(19) United States
(12) Patent Application Publication
(10) Pub. No.: US 2026/0032265 A1
(43) Pub. Date: Jan. 29, 2026

(54) USING MULITPLE REFERENCE LINES FOR PREDICTION

(71) Applicant: MEDIATEK INC., Hsinchu City (TW)

(72) Inventors: Hong-Hui CHEN, Hsinchu City (TW); Man-Shu CHIANG, Hsinchu City (TW); Hsin-Yi TSENG, Hsinchu City (TW); Chia-Ming TSAI, Hsinchu City (TW); Chih-Wei HSU, Hsinchu City (TW)

(21) Appl. No.: 18/996,475

(22) PCT Filed: Jul. 17, 2023
(86) PCT No.: PCT/CN2023/107656

§ 371 Date: Jan. 17, 2025

Related U.S. Application Data
(60) Provisional application No. 63/369,526, filed on Jul. 27, 2022.
(60) Provisional application No. 63/375,703, filed on Sep. 15, 2022.

(51) Int. Cl. H04N 19/176; H04N 19/105; H04N 19/159; H04N 19/186; H04N 19/593

(52) U.S. Cl. CPC H04N 19/176; H04N 19/105; H04N 19/159; H04N 19/186; H04N 19/593

(57) ABSTRACT

A method using multiple reference lines for predictive coding is provided. A video coder receives data for a block of pixels to be encoded or decoded as a current block of a current picture of a video. The video coder receives or signals a selection of first and second reference lines among a plurality of reference lines that neighbor the current block. The video coder blends the first and second reference lines into a fused reference line. The video coder generates a prediction of the current block by using samples of the fused reference line. The video coder encodes or decodes the current block by using the generated prediction.

### CROSS REFERENCE TO RELATED PATENT APPLICATION(S)

The present disclosure is part of a non-provisional application that claims the priority benefit of U.S. Provisional Patent Application Nos. 63/369,526 and 63/375,703, filed on 27 Jul. 2022 and 15 Sep. 2022, respectively. Contents of above-listed applications are herein incorporated by reference.

### TECHNICAL FIELD

The present disclosure relates generally to video coding. In particular, the present disclosure relates to methods of coding pixel blocks by intra-prediction and/or cross-component prediction using multiple reference lines.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUS). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method using multiple reference lines for predictive coding is provided. A video coder receives data for a block of pixels to be encoded or decoded as a current block of a current picture of a video. The video coder receives or signals a selection of first and second reference lines among a plurality of reference lines that neighbor the current block. The video coder blends the first and second reference lines into a fused reference line. The video coder generates a prediction of the current block by using samples of the fused reference line. The video coder encodes or decodes the current block by using the generated prediction.

Each reference line includes a set of pixel samples that forms an L-shape near the current block. The multiple reference lines may include one reference line that is adjacent to the current block and two or more reference lines that are not adjacent to the current block. For example, the first reference line may be adjacent to the current block, or both the first and second reference lines are not adjacent to the current block.

In some embodiments, the selection of the first and second reference lines includes an index that represents a combination that includes the first and second reference lines, where different combinations of two or more reference lines are represented by different indices. The different indices representing different combinations of reference lines are determined based on costs of the different combinations (e.g., the different combinations are ordered based on costs.) In some embodiments, each combination further specifies an intra-prediction mode by which an intra-prediction of the current block is generated based on the fused reference line. In some embodiments, the selection of the first and second reference lines includes first and second indices. The first index may identify the first reference line and the second index may be an offset to be added to the first index for identifying the second reference line.

In some embodiments, the video coder may perform decoder side intra-mode derivation (DIMD) based on the fused reference line. Specifically, the video coder derives a HoG having bins that correspond to different intra prediction angles, where an entry is made to a bin when a gradient computed based on the fused reference line indicates a particular intra prediction angle that corresponds to the bin. The video coder may identify two or more intra prediction modes based on the HoG and generate the prediction of the current block based on the identified two or more intra prediction modes.

In some embodiments, the video coder may perform cross-component prediction based on the fused reference line. For example, the video coder may derive a linear model based on luma and chroma component samples of the fused reference line, with the prediction of the current block being chroma prediction that is generated by applying the derived linear model to luma samples of the current block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIGS. 2A-B conceptually illustrate top and left reference templates with extended lengths for supporting wide-angular direction mode for non-square blocks of different aspect ratios.

FIG. 3 illustrates using decoder-side intra mode derivation (DIMD) to implicitly derive an intra prediction mode for a current block.

FIG. 4 illustrates using template-based intra mode derivation (TIMD) to implicitly derive an intra prediction mode for a current block.

FIG. 5 conceptually illustrates chroma and luma samples that are used for derivation of linear model parameters.

FIG. 6 shows an example of classifying the neighbouring samples into groups.

FIG. 7 illustrates reconstructed luma and chroma samples that are used for DIMD chroma intra prediction.

FIGS. 8A-C illustrates blocks neighboring a current block that are used to generate multiple intra-predictions.

FIG. 9 illustrates refinement of intra-prediction by gradient of neighboring reconstruction samples.

FIG. 10 shows the nearest multiple L-shapes for HoG accumulation.

FIG. 11 illustrates pixels near block boundary that are used for computing boundary matching (BM) costs.

FIGS. 12A-B illustrate fusion of pixels neighboring a coding unit (CU).

FIGS. 13A-D illustrate several different types of HoGs having different characteristics.

FIG. 14 illustrates adjacent and non-adjacent reference lines and reference samples of the current block.

FIGS. 15A-F show elimination of corners of L-shapes reference lines for DIMD.

FIG. 16 shows blending of reference lines based on intra prediction mode.

FIG. 17 illustrates various luma sample phases and chroma sample phases.

FIGS. 18A-B illustrate multiple neighboring reference lines being combined into one line for deriving mode1 parameters in CCLM/MMLM.

FIG. 19 illustrates an example video encoder that may use multiple reference lines when encoding a block of pixels.

FIGS. 20A-C illustrate portions of the video encoder that implement predictions by multiple reference lines.

FIG. 21 conceptually illustrates a process that uses multiple reference line to generate a prediction when encoding a block of pixels.

FIG. 22 illustrates an example video decoder that may use multiple reference lines when decoding a block of pixels.

FIGS. 23A-C illustrate portions of the video decoder that implement predictions by multiple reference lines.

FIG. 24 conceptually illustrates a process that uses multiple reference line to generate a prediction when decoding a block of pixels.

FIG. 25 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

Intra-prediction method exploits one reference tier adjacent to the current prediction unit (PU) and one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

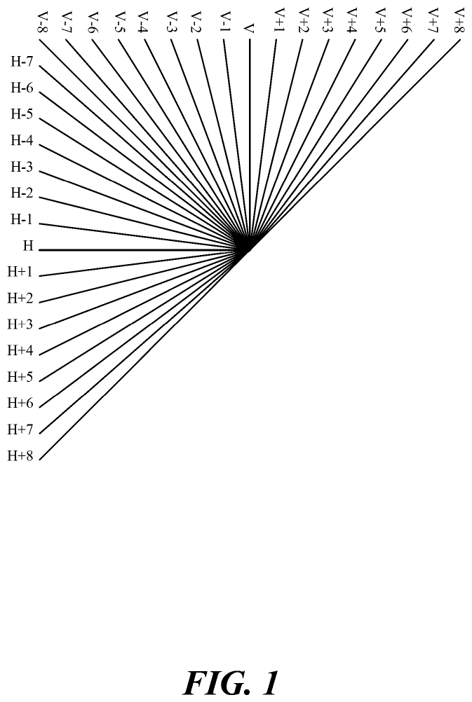

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1˜H+8, H-1˜H-7, V, V+1˜V+8, V-1˜V-8 are used. Generally directional modes can be represented as either as H+k or V+k modes, where k=+1, +2, . . . , +8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from +1 to +16. These denser directional intra prediction modes apply for all block sizes and for both luma and chroma intra predictions. By including DC and Planar modes, the number of intra-prediction mode is 35 (or 67).

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

The MPM list is constructed based on intra modes of the left and above neighboring block. Suppose the mode of the left neighboring block is denoted as Left and the mode of the above neighboring block is denoted as Above, and the unified MPM list may be constructed as follows:
When a neighboring block is not available, its intra mode is set to Planar by default.
If both modes Left and Above are non-angular modes:
   MPM list→{Planar, DC. V. H. V−4. V+4}
If one of modes Left and Above is angular mode, and the other is non-angular:
   Set a mode Max as the larger mode in Left and Above:
   MPM list→{Planar, Max, Max−1, Max+1, Max−2, Max+2}
If Left and Above are both angular and they are different:
   Set a mode Max as the larger mode in Left and Above.
   Set a mode Min as the smaller mode in Left and Above
   If Max-Min is equal to 1:
      MPM list→{Planar, Left, Above, Min−1, Max+1, Min−2}.Otherwise, if Max-Min is greater than or equal to 62:
      MPM list→{Planar, Left, Above, Min+1, Max−1, Min+2}.Otherwise, if Max-Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
MPM list→{Planar, Left, Left−1, Left+1, Left−2, Left+2}

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

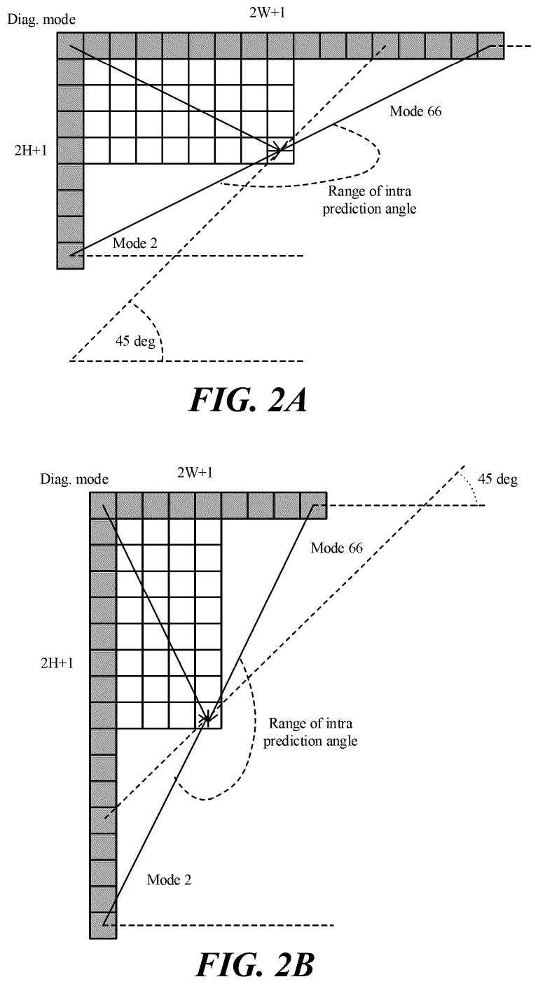

For some embodiments, the total number of intra prediction modes is unchanged, i.e., 67, and the intra mode coding method is unchanged. To support these prediction directions, a top reference template with length 2 W+1 and a left reference template with length 2H+1 are defined. FIGS. 2A-B conceptually illustrate top and left reference templates with extended lengths for supporting wide-angular direction mode for non-square blocks of different aspect ratios.

The number of replaced modes in wide-angular direction mode depends on the aspect ratio of a block. The replaced intra prediction modes for different blocks of different aspect ratios are shown in Table 1 below.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Modes 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

### II. Decoder Side Intra Mode Derivation (DIMD)

Decoder-Side Intra Mode Derivation (DIMD) is a technique in which two intra prediction modes/angles/directions are derived from the reconstructed neighbor samples (template) of a block, and those two predictors are combined with the planar mode predictor with the weights derived from the gradients. The DIMD mode is used as an alternative prediction mode and is always checked in high-complexity RDO mode. To implicitly derive the intra prediction modes of a blocks, a texture gradient analysis is performed at both encoder and decoder sides. This process starts with an empty Histogram of Gradient (HoG) having 65 entries, corresponding to the 65 angular/directional intra prediction modes. Amplitudes of these entries are determined during the texture gradient analysis.

A video coder performing DIMD performs the following steps: in a first step, the video coder picks a template of T=3 columns and lines from respectively left and above current block. This area is used as the reference for the gradient based intra prediction modes derivation. In a second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of the 65 angular intra prediction modes. Once the intra prediction modes index of current window is derived as idx, the amplitude of its entry in the HoG[idx] is updated by addition of

$$ampl = \vert {G}_{x} \vert + \vert {G}_{y} \vert$$

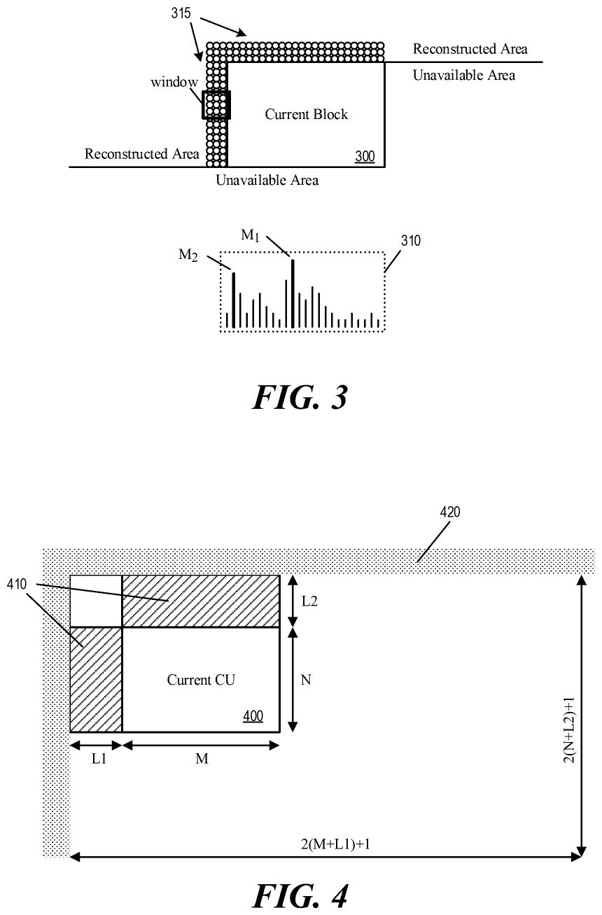

FIG. 3 illustrates using decoder-side intra mode derivation (DIMD) to implicitly derive an intra prediction mode for a current block. The figure shows an example Histogram of Gradient (HoG) 310 that is calculated after applying the above operations on all pixel positions in a template 315 that includes neighboring lines of pixel samples around a current block 300. Once the HoG is computed, the indices of the two tallest histogram bars (M₁ and M₂) are selected as the two implicitly derived intra prediction modes (IPMs) for the block. The prediction of the two IPMs are further combined with the planar mode as the prediction of DIMD mode. The prediction fusion is applied as a weighted average of the above three predictors (M₁ prediction, M₂ prediction, and planar mode prediction). To this aim, the weight of planar may be set to 21/64 (˜⅓). The remaining weight of 43/64 (˜⅔) is then shared between the two HoG IPMs, proportionally to the amplitude of their HoG bars. The prediction fusion or combined prediction for DIMD can be:

$$\begin{matrix}{Pred}_{DIMD} = ( 43 * ( w 1 * {pred}_{M 1} + w 2 * {pred}_{M 2} ) + 21 * {pred}_{planar} ) ≫ 6 \\ w 1 = {amp}_{M 1} / ( {amp}_{M 1} + {amp}_{M 2} ) \\ w 2 = {amp}_{M 2} / ( {amp}_{M 1} + {amp}_{M 2} )\end{matrix}$$

In addition, the two implicitly derived intra prediction modes are added into the most probable modes (MPM) list, so the DIMD process is performed before the MPM list is constructed. The primary derived intra mode of a DIMD block is stored with a block and is used for MPM list construction of the neighboring blocks.

### III. Template-Based Intra Mode Derivation (TIMD)

For mode selection, template matching method can be applied by computing the cost between reconstructed samples and predicting samples. One of the examples is template-based intra mode derivation (TIMD). TIMD is a coding method in which the intra prediction mode of a CU is implicitly derived by using a neighboring template at both encoder and decoder, instead of the encoder signaling the exact intra prediction mode to the decoder.

FIG. 4 illustrates using template-based intra mode derivation (TIMD) to implicitly derive an intra prediction mode for a current block 400. As illustrated, the neighboring pixels of the current block 400 is used as template 410. For each candidate intra mode, prediction samples of the template 410 are generated using the reference samples, which are in a L-shape reference region 420 above and left of the template 410. A TM cost for a candidate intra mode cost is calculated based on a difference (e.g., SATD) between reconstructed samples of the template and the prediction samples of the template generated by the candidate intra mode. The candidate intra prediction mode with the minimum cost is selected (as in the DIMD mode) and used for intra prediction of the CU. The candidate modes may include 67 intra prediction modes (as in VVC) or extended to 131 intra prediction modes. MPMs may be used to indicate the directional information of a CU. Thus, to reduce the intra mode search space and utilize the characteristics of a CU, the intra prediction mode is implicitly derived from the MPM list.

In some embodiments, for each intra prediction mode in the MPM list, the SATD between the prediction and reconstructed samples of the template is calculated as the TM cost of the intra mode. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of two selected modes (mode1 and mode2) are compared with a threshold, in the test the cost factor of 2 is applied as follows:

$$costMode 2 < 2 * costMode 1$$

If this condition is true, the prediction fusion is applied, otherwise only mode1 is used. Weights of the modes are computed from their SATD costs as follows:

$$weight 1 = costMode 2 / ( costMode 1 + costMode 2 )$$

$$weight 2 = 1 - weight 1$$

### IV. Cross Component Linear Model (CCLM)

Cross Component Linear Model (CCLM) or Linear Model (LM) mode is a cross component prediction mode in which chroma components of a block is predicted from the collocated reconstructed luma samples by linear models. The parameters (e.g., scale and offset) of the linear model are derived from already reconstructed luma and chroma samples that are adjacent to the block. For example, in VVC, the CCLM mode makes use of inter-channel dependencies to predict the chroma samples from reconstructed luma samples. This prediction is carried out using a linear model in the form of:

$$P ( i , j ) = α \cdot {rec}_{L}^{′} ( i , j ) + β \qquad ( 1 )$$

P(i, j) in eq. (1) represents the predicted chroma samples in a CU (or the predicted chroma samples of the current CU) and

$${rec}_{L}^{′} ( i , j )$$

represents the down-sampled reconstructed luma samples of the same CU (or the corresponding reconstructed luma samples of the current CU).

The CCLM mode1 parameters α (scaling parameter) and β (offset parameter) are derived based on at most four neighboring chroma samples and their corresponding down-sampled luma samples. In LM A mode (also denoted as LM-T mode), only the above or top-neighboring template is used to calculate the linear model coefficients. In LM_L mode (also denoted as LM-L mode), only left template is used to calculate the linear model coefficients. In LM-LA mode (also denoted as LM-LT mode), both left and above templates are used to calculate the linear model coefficients.

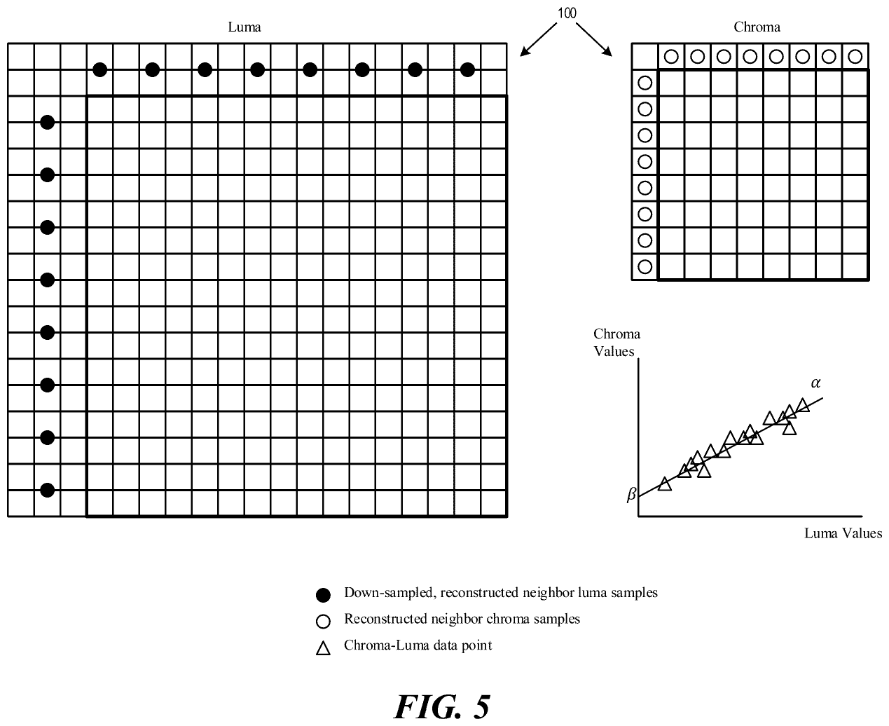

FIG. 5 conceptually illustrates chroma and luma samples that are used for derivation of linear model parameters. The figure illustrates a current block 500 having luma component samples and chroma component samples in 4:2:0 format. The luma and chroma samples neighboring the current block are reconstructed samples. These reconstructed samples are used to derive the cross-component linear model (parameters α and β). Since the current block in in 4:2:0 format, the luma samples are down-sampled first before being used for linear model derivation. In the example, there are 16 pairs of reconstructed luma (down-sampled) and chroma samples neighboring the current block. These 16 pairs of luma versus chroma values are used to derive the linear model parameters.

Suppose the current chroma block dimensions are W×H, then W′ and H′ are set as
W′=W, H′=H when LM-LT mode is applied;
W′=W+H when LM-T mode is applied;
H′=H+W when LM-L mode is applied

The above neighboring positions are denoted as S[0, −1] . . . S[W′−1, −1] and the left neighboring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM mode is applied (both above and left neighboring samples are available);

S[W′/8, −1], S[3*W′/8, −1], S[5*W′/8, −1], S[7*W′/8, −1] when LM-T mode is applied (only the above neighboring samples are available);
S[−1, H′/8], S[−1, 3*H′/8], S[−1, 5*H′/8], S[−1, 7*H′/8] when LM-L mode is applied (only the left neighboring samples are available);

The four neighboring luma samples at the selected positions are down-sampled and compared four times to find two larger values: x_{A}⁰, and x_{A}¹, and two smaller values: x_{B}⁰, and x_{B}¹. Their corresponding chroma sample values are denoted as y_{A}⁰, y_{A}¹, y_{B}⁰, and y_{B}¹. Then X_{A}, X_{B}, Y_{A}, and Y_{B} are derived as:

$${X}_{a} = ( {x}_{A}^{0} + x {}_{A}^{1} + 1 ) ≫ 1 ; {X}_{b} = ( {x}_{B}^{0} + {x}_{B}^{1} + 1 ) ≫ 1 ; \qquad ( 2 )$$

$${Y}_{a} = ( y {}_{A}^{0} + {y}_{A}^{1} + 1 ) ≫ 1 ; {Y}_{b} = ( y {}_{B}^{0} + y {}_{B}^{1} + 1 ) ≫ 1 \qquad ( 3 )$$

The linear model parameters α and β are obtained according to the following equations

$$α = \frac{{Y}_{a} - {Y}_{b}}{{X}_{a} - {X}_{b}} \qquad ( 4 )$$

$$β = {Y}_{b} - α \cdot {X}_{b} \qquad ( 5 )$$

The operations to calculate the α and β parameters according to eq. (4) and (5) may be implemented by a look-up table. In some embodiments, to reduce the memory required for storing the look-up table, the diff value (difference between maximum and minimum values) and the parameter a are expressed by an exponential notation. For example, diff is approximated with a 4-bit significant part and an exponent. Consequently, the table for 1/diff is reduced to 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 6 )$$

This reduces the complexity of the calculation as well as the memory size required for storing the needed tables.

In some embodiments, to get more samples for calculating the CCLM mode1 parameters α and β, the above template is extended to contain (W+H) samples for LM-T mode, the left template is extended to contain (H+W) samples for LM-L mode. For LM-LT mode, both the extended left template and the extended above templates are used to calculate the linear model coefficients.

To match the chroma sample locations for 4:2:0 video sequences, two types of down-sampling filters are applied to luma samples to achieve 2 to 1 down-sampling ratio in both horizontal and vertical directions. The selection of down-sampling filter is specified by a sequence parameter set (SPS) level flag. The two down-sampling filters are as follows, which correspond to “type-0” and “type-2” content, respectively.

$${{rec}_{L}}^{′} ( i , j ) = \text{} [ \text{} {rec}_{L} ( 2 i - 1 , 2 j - 1 ) + 2 * {rec}_{L} ( 2 i - 1 , 2 j - 1 ) + {rec}_{L} ( 2 i + 1 , 2 j - 1 ) + {rec}_{L} ( 2 i - 1 , 2 j ) + 2 * {rec}_{L} ( 2 i , 2 j ) + {rec}_{L} ( 2 i + 1 , 2 j ) + 4 ] ≫ 3 \qquad ( 7 )$$

$${{rec}_{L}}^{′} ( i , j ) = [ {rec}_{L} ( 2 i , 2 j - 1 ) + {rec}_{L} ( 2 i - 1 , 2 j ) + 4 * {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad ( 8 )$$

In some embodiments, only one luma line (general line buffer in intra prediction) is used to make the down-sampled luma samples when the upper reference line is at the CTU boundary.

In some embodiments, the α and β parameters computation is performed as part of the decoding process, and is not just as an encoder search operation. As a result, no syntax is used to convey the α and β values to decoder.

For chroma intra mode coding, a total of 8 intra modes are allowed. Those modes include five traditional intra modes and three cross-component linear model modes (LM_LA, LM_A, and LM_L). Chroma intra mode coding may directly depend on the intra prediction mode of the corresponding luma block. Chroma intra mode signaling and corresponding luma intra prediction modes are according to the following table:

| | |
|---|---|
| Chroma Intra | Corresponding Luma Intra |
| Prediction | Prediction Mode |

| Mode | 0 | 50 | 18 | 1 | X(0 ≤ X ≤ 66) |
|---|---|---|---|---|---|
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

Since separate block partitioning structure for luma and chroma components is enabled in I slices, one chroma block may correspond to multiple luma blocks. Therefore, for chroma derived mode (DM) mode, the intra prediction mode of the corresponding luma block covering the center position of the current chroma block is directly inherited.

A single unified binarization table (mapping to bin string) is used for chroma intra prediction mode according to the following table:

| Chroma intra | |
|---|---|
| prediction mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In the Table, the first bin indicates whether it is regular (0) or LM mode (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma pred_mode can be discarded prior to the entropy coding. Or, in other words, the first bin is inferred to be 0 and hence not coded. This single binarization table is used for both sps_cclm_enabled_flag equal to 0 and 1 cases. The first two bins in the table are context coded with its own context model, and the rest bins are bypass coded.

In addition, in order to reduce luma-chroma latency in dual tree, when the 64×64 luma coding tree node is not split (and ISP is not used for the 64×64 CU) or partitioned with QT, the chroma CUs in 32×32/32×16 chroma coding tree node are allowed to use CCLM in the following way:
If the 32×32 chroma node is not split or partitioned with QT split, all chroma CUs in the 32×32 node can use CCLM.
If the 32×32 chroma node is partitioned with Horizontal BT, and the 32×16 child node does not split or uses Vertical BT split, all chroma CUs in the 32×16 chroma node can use CCLM.
In all the other luma and chroma coding tree split conditions, CCLM is not allowed for chroma CU.

### V. Multi-Model CCLM (MMLM)

Multiple mode1 CCLM mode (MMLM) uses two models for predicting the chroma samples from the luma samples for the whole CU. Similar to CCLM, three multiple mode1 CCLM modes (MMLM_LA, MMLM_A, and MMLM_L) are used to indicate if both above and left neighboring samples, only above neighboring samples, or only left neighboring samples are used in mode1 parameters derivation.

In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

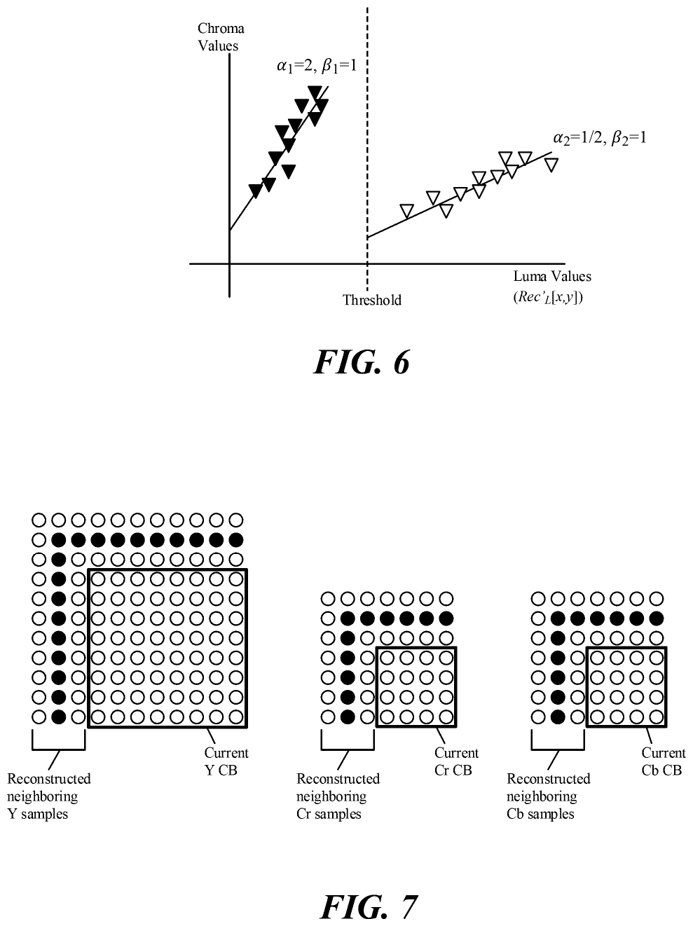

FIG. 6 shows an example of classifying the neighbouring samples into two groups. Threshold is calculated as the average value of the neighbouring reconstructed luma samples. A neighbouring sample at [x,y] with Rec′_{L}[x,y]<=Threshold is classified into group 1; while a neighbouring sample at [x,y] with Rec′_{L}[x,y]>Threshold is classified into group 2. Thus, the multi-model CCLM prediction for the chroma samples is:

$$\begin{matrix}Pre {d}_{c} [ x , y ] = {α}_{1} \times Rec {}_{L}^{′} [ x , y ] + {β}_{1} if Rec {}_{L}^{′} [ x , y ] \leq Threshold \\ {Pred}_{c} [ x , y ] = {α}_{2} \times Rec {}_{L}^{′} [ x , y ] + {β}_{2} if Rec {}_{L}^{′} [ x , y ] > Threshold\end{matrix}$$

### VI. DIMD Chroma Mode

The DIMD chroma mode uses the DIMD derivation method to derive the chroma intra prediction mode of the current block based on the neighboring reconstructed Y, Cb and Cr samples in the second neighboring row and column. FIG. 7 illustrates reconstructed luma and chroma (Y, Cb and Cr) samples that are used for DIMD chroma intra prediction, specifically luma and chroma samples in the second neighboring row and column. A horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the derived mode (DM), the intra prediction mode with the second largest histogram amplitude value is used as the DIMD chroma mode. (For Chroma DM mode, the intra prediction mode of the corresponding or collocated luma block covering the center position of the current chroma block is directly inherited.) A CU level flag may be signaled to indicate whether the proposed DIMD chroma mode is applied.

### VII. Fusion of Chroma Intra Prediction Modes

In some embodiments, predictors produced by MMLM_LT mode can be fused with predictors produced by other non-LM modes (e.g., DM mode, the four default modes, etc.) according to the following:

$$pred = ( w 0 * p r e d 0 + w 1 * p r e d 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}. If a non-LM mode is selected, a flag may be signaled to indicate whether the fusion is applied. In some embodiments, the fusion of chroma prediction modes is only applied to I slices.

In some embodiments, the DIMD chroma mode and the fusion of chroma intra prediction modes can be combined. Specifically, the DIMD chroma mode described in Section VI above is applied. I slices, the DM mode, the four default modes, and the DIMD chroma mode can be fused with the MMLM LT mode using the weighting described. In some embodiments, for non-I slices, only the DIMD chroma mode can be fused with the MMLM_LT mode using equal weights.

### VIII. Combining Multiple Intra Predictions

In some embodiments, a final intra prediction of the current block is produced by combining multiple intra predictions. The multiple intra predictions may come from intra angular prediction, intra DC prediction, intra planar prediction, or other intra prediction tools. In some embodiment, one of the multiple intra predictions (denoted as P1) may be derived from an intra angular mode which is implicitly derived by the gradient of neighboring reconstructed samples (e.g., by DIMD) and has the highest gradient histogram bar, and another one of the multiple intra predictions (denoted as P2) may be implicitly derived by template matching (e.g., by TIMD), most frequently selected intra prediction mode of neighboring 4×4 blocks, the selected intra mode after excluding high texture area, or explicitly signal the angular mode, or explicitly signal and derived from one of MPMs. In some embodiment, P1 may be an intra angular mode which is implicitly derived by the gradient of neighboring reconstructed samples (e.g., by DIMD) and the intra mode angle is greater than or equal to the diagonal intra angle (e.g., mode 34 in 67 intra mode angles, mode 66 in 131 intra mode angles), and P2 may be implicitly derived by DIMD and the intra mode angle is less than the diagonal intra angle. In still another embodiment, P1 may be an intra angular mode which implicitly derived by DIMD, and P2 may be implicitly derived from neighboring blocks.

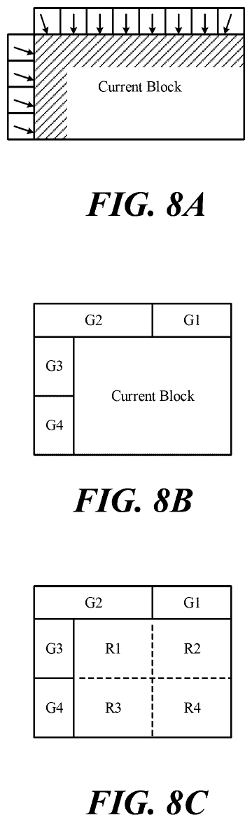

FIGS. 8A-C illustrates blocks neighboring a current block that are used to generate multiple intra-predictions. FIG. 8A shows the P2 of top and left region (shown as slashed area) of the current block being derived based on the intra prediction mode of the neighboring 4×4 blocks.

In some embodiments, P1 may be an intra angular mode that is implicitly derived by DIMD, and P2 may be the planar prediction that refers to any smooth intra prediction method utilizing multiple reference samples at corners of the current block, such as the planar prediction as defined in HEVC/VVC, or other modified or altered forms of planar prediction. In some embodiments, the final intra prediction of the current block is computed according to:

$$weight 1 \times P 1 + weight 2 \times P 2 , ( P 1 + P 2 + 1 ) ≫ 1 ,$$

$$or$$

$$Max ( P 1 , P 2 ) = ( P 1 + P 2 + abs ( P 1 - P 2 ) ) ≫ 1.$$

In some embodiments, as shown in FIG. 8B, the neighboring window positions of the current block is partitioned into many groups (e.g., G1, G2, G3, and G4), each group selects an intra angular mode, and the final intra prediction is the fusion of these selected intra angular predictions with weights.

In some embodiments, as shown in FIG. 8C, the final intra prediction may be partitioned into many regions, the intra prediction of each region may depends on the neighboring window positions. For example, the intra prediction of R1 region is fusion by the derived intra predictions from G2 and G3, the intra prediction of R2 region is fusion by the derived intra predictions from G1 and G3, the intra prediction of R3 region is fusion by the derived intra predictions from G2 and G4, and/or the intra prediction of R4 region is fusion by the derived intra predictions from G1 and G4.

In some embodiments, when the gradient magnitude after applying Sobel filter is less than a threshold (which varies with block size), all derived DIMD modes are set as Planar mode, or the current prediction is set as planar prediction. In still another embodiment, when the sum of accumulated gradient magnitude of the HoG after applying Sobel filter is greater than a threshold (which varies with block size) or the accumulated gradient magnitude of the first DIMD mode after applying Sobel filter is greater than a threshold (which varies with block size), the current intra prediction is set as the prediction from first DIMD mode (without blending with planar prediction).

In some embodiments, in DIMD process, the boundary smoothness between the candidate intra angular mode prediction and the neighboring reconstructed samples are further considered in deriving the final intra angular mode prediction. For example, suppose there are N intra mode candidates derived by DIMD, the SAD between the top/left prediction samples and the neighboring samples of each intra mode candidates is considered in determining the final intra angular mode prediction.

In some embodiments, to improve the coding performance of DIMD, a delta angle is signaled to decoder side. The final intra angular mode is the intra mode derived by DIMD plus the delta angle. In some embodiment, encoder side may use the original samples to estimate the best intra angular mode. To reduce the mode signaling overhead, DIMD is applied to implicitly derive an intra angular mode, then the delta angle between the best intra angular mode and the DIMD derived intra mode is signaled to decoder side. The delta angle may contain a syntax for the magnitude of delta angle, and a syntax for the sign of delta angle. The final intra angular mode at decoder side is the DIMD derived intra mode plus the delta angle.

To simplify the DIMD process, the HoG computation is from partially selected neighboring window positions to reduce computations. For some embodiments, the DIMD process may choose the above-middle, above-right, left-middle, left-bottom neighboring window positions to apply Sobel filters to build HoG. Or it could choose even or odd neighboring window positions to apply Sobel filters to build HoG. For another embodiment, the angular mode is implicitly derived by applying Sobel filter to the above-selected window position (e.g., the above neighboring window position between 0, . . . , current block width−1, the above neighboring window position between 0, . . . , 2×current block width−1, or 0, . . . , current block width+current block height−1), and another angular mode is implicitly derived by applying Sobel filter to left-selected window position (e.g., the left neighboring position between 0, . . . , current block height−1, the left neighboring position between 0, . . . , 2×current block height−1, or 0, . . . , current block width+current block height−1), then HoG computation is not required because only one position is selected therefore HoG does not need to be built.

In some embodiments, to improve the coding performance of DIMD, DIMD prediction is applied to chroma CUs to implicitly derived intra angular modes. In one embodiment, if candidate intra chroma modes are DC, vertical, horizontal, planar, and DM, DIMD prediction is applied to derive the final intra angular mode. In another embodiment, a flag is used to indicate if DIMD is used to derive final intra angular mode. If the flag is true, DIMD implicitly derived the final intra angular mode and excludes the DC, vertical, horizontal, planar, and DM modes in the candidate intra mode list.

In some embodiments, after deriving the intra angular mode by DIMD, a fine search may be performed around the derived intra angular mode. In some embodiments, DIMD derives the intra angular mode from 2 to 67 modes. Assume the intra angular mode k is derived, the encoder side may insert more intra modes search between (k−1) and (k+1), and signal a delta value to indicate the final intra prediction angular mode.

In some embodiments, when deriving the intra angular mode by DIMD, the video coder may exclude or lower the gradient of the neighboring inter-coded positions in computing gradient histogram or increase the cost between prediction and reconstruction of inter-coded template.

To reduce the required comparisons in DIMD, the candidate intra angular modes in DIMD may depend on block size or the prediction mode of neighboring blocks. In some embodiments, the candidate intra angular modes in DIMD for small CUs (e.g., CU width+height or CU area is less than a threshold) is less than the candidate intra angular modes in DIMD for large CUs. For example, the number of intra angular mode candidates in DIMD for small CUs is 34, the number of intra angular mode candidates in DIMD for larger CUs is 67. In still another embodiment, the candidate intra angular modes in DIMD could be further constrained or reduced in a predefined range. For example, if the current intra angular modes could support up to 67 modes (i.e., 0, 1, 2, 3, . . . , 67), it could constrain the candidate intra angular modes in DIMD with the subset of these 67 modes (i.e., candidates <67 modes). The constrained candidates could be {0, 1, 2, 4, 6, 8, . . . , 66}, {0, 1, 3, 5, 7, 9, . . . , 65}, {0, 1, 2, 3, 4, 5, . . . , 34}, or {34, 35, 36, 37, 38, . . . , 67}. This constrained condition may be signaled in PPS, SPS, picture header, slice header, CTU-level syntax, or implicitly derived depends on other syntax, or always applied. For still another example, if the constrained condition is signaled, the CUS coded with only DIMD use less candidate intra angular modes to derive the final intra angular mode.

In some embodiments, the candidate intra angular modes in DIMD may be further constrained by the prediction mode of neighboring blocks. For example, if the top neighboring CU are inter-coded in skip mode, the intra angular modes greater than diagonal intra angular mode (e.g., mode 66 in 131 intra angular modes, mode 34 in 67 intra angular modes, mode 18 in 34 intra angular modes) are excluded from the candidate intra angular modes in DIMD. If the left neighboring CUs are inter-coded in skip mode, the intra angular modes less than diagonal intra angular mode (e.g., mode 66 in 131 intra angular modes, mode 34 in 67 intra angular modes, mode 18 in 34 intra angular modes) are excluded from the candidate intra angular modes in DIMD.

In some embodiments, the number of neighboring lines to compute HoG in DIMD may be signaled in PPS, SPS, picture header, slice header, CTU-level syntax, or implicitly derived depends on other syntax. For example, the video coder may use more neighboring lines to compute HoG in DIMD when the current block size is less than or greater than a threshold.

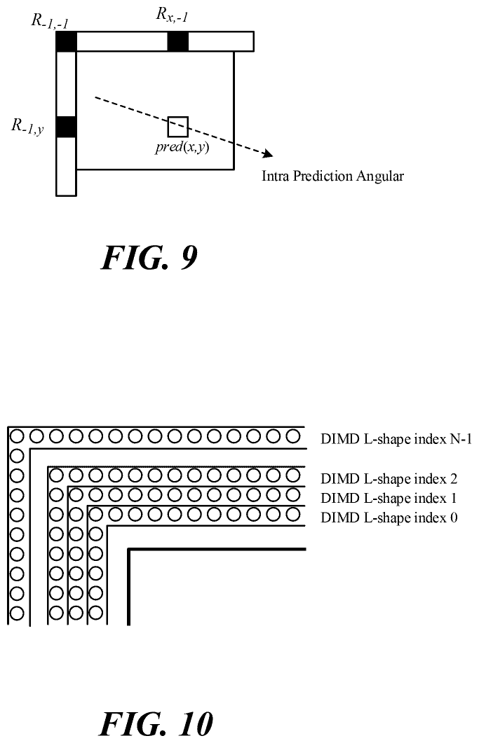

After producing an intra angular mode prediction by DIMD, the intra prediction is further refined by the gradient of neighboring reconstruction samples. In some embodiments, the intra prediction is refined by the gradient of neighboring reconstruction samples. FIG. 9 illustrates refinement of intra-prediction by gradient of neighboring reconstruction samples. As illustrated, if the current intra prediction is from the left-side neighboring reconstruction samples, the current prediction at (x, y) is further refined by the gradient between the above-left corner sample (e.g., R_{-1,-1}) and the current left neighboring sample (e.g., R_{-1,y}). Then, the refined prediction at (x, y) is (w₁×(R_{x,-1}+(R_{-1,-1}−R−_{1,y})+w₂×pred (x, y)/(w₁+w₂). For still another example, if the current intra prediction is from the above-side neighboring reconstruction samples, the current prediction at (x, y) is further refined by the gradient between the above-left corner sample (e.g., R_{-1,-1}) and the current above neighboring sample (e.g., R_{x,-1}). Then, the refined prediction at (x, y) is (w₁×(R−_{1,y}+(R_{-1,y-1}−R_{x,-1}))+w₂×pred (x, y))/(w₁+w₂).

In some embodiments, when the current block is a narrow block (e.g., width<<height) or a wide block (e.g., width>>height), the horizontal and vertical Sobel filters are replaced by the following two matrices to map to support wide-angle intra modes.

$$Vertical Sobel filter = [ \begin{matrix}0 & - 1 & - 2 \\ 1 & 0 & - 1 \\ 2 & 1 & 0\end{matrix} ] ,$$

$$Horizontal Sobel filter = [ \begin{matrix}- 2 & - 1 & 0 \\ - 1 & 0 & 1 \\ 0 & 1 & 2\end{matrix} ] , or$$

$$Vertical Sobel filter = [ \begin{matrix}- 2 & - 1 & 0 \\ - 1 & 0 & 1 \\ 0 & 1 & 2\end{matrix} ] ,$$

$$Horizontal Sobel filter = [ \begin{matrix}0 & - 1 & - 2 \\ 1 & 0 & - 1 \\ 2 & 1 & 0\end{matrix} ] .$$

If the mapped intra angular mode is greater than 135 (e.g., mode 66) or less than −45 (e.g., mode 2), the mapped intra angular mode is converted to the intra mode at another side. For example, if the mapped intra angular mode is greater than mode 66, then the converted intra prediction mode is set to the mapped intra angular mode equaling original mode−65. For another example, if the mapped intra angular mode is less than mode 2, then the converted intra prediction mode is set to the mapped intra angular mode equaling original mode+67.

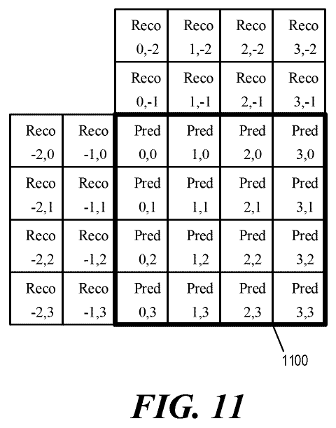

In some embodiments, non-adjacent HoG accumulation can be applied for DIMD. Explicit signaling for selecting one of the nearest N L-shapes for HoG accumulation can be applied. FIG. 10 shows the nearest multiple L-shapes for HoG accumulation. As illustrated, the L-shape with index equal to zero is the L-shape originally utilized by DIMD. L-shapes with index larger than 1 are non-adjacent L-shapes. If the statistics of the gradient of farther L-shapes are more representative of the intra direction of the CU, extra coding gain is achieved by using non-adjacent L-shapes for HoG accumulation. In addition to explicit signaling, implicit L-shape selection by boundary matching cost can be used. In some embodiments, boundary matching (BM) can be used as a cost function to evaluate the discontinuity across block boundary. FIG. 11 illustrates pixels near block boundary that are used for computing boundary matching (BM) costs. In the figure, Reco (or R) refers to reconstructed samples neighboring the current block. Pred (or P) refers to predicted samples of the current block. The formula to calculate BM cost is:

$$cost = {\sum }_{x = o}^{w} ( \vert 2 {P}_{x , 1} - {P}_{x , 2} - {R}_{x , 0} \vert + \vert 2 {R}_{x , 0} - {P}_{x , 1} - {R}_{x , - 1} \vert ) + {\sum }_{y = o}^{h} ( \vert 2 {P}_{1 , y} - {P}_{2 , y} - {R}_{0 , y} \vert + \vert 2 {R}_{0 , y} - {P}_{1 , y} - {R}_{- 1 , y} \vert ) \qquad ( 9 )$$

### IX. DIMD Based on Multiple Reference Lines

In some embodiments, to calculate the cost, the prediction for the CU is generated by one of the N candidate L-shaped reference lines for HoG accumulation. The boundary matching cost is calculated by Eq. (9) with the predicting samples and the reconstructed sample around the CU boundary. In some embodiments, for this extended DIMD method, multiple neighboring reference L-shapes are adopted for determining DIMD intra modes. When DIMD is used for the current block, the video coder may either implicitly derive the reference L-shape at both encoder-side and decoder-side, or explicitly indicate the reference L-shape in the bitstream.

In some embodiments, when DIMD is used and N neighboring reference L-shapes are available for the current block, the candidate intra prediction modes are derived by the statistical analysis (e.g., HoG) of the neighboring reconstructed samples. The predictions of the candidate intra prediction modes are then combined with the prediction of planar mode to produce the final intra prediction. While generating the predictions of candidate intra prediction modes or the prediction of Planar mode, the video coder may use one of N neighboring reference L-shapes, and the used neighboring reference L-shape is explicitly indicated in the bitstream.

In some embodiments, one of N neighboring reference L-shapes is implicitly derived by boundary matching. When doing boundary matching, a boundary matching cost for a candidate mode refers to the discontinuity measurement (e.g., including top boundary matching and/or left boundary matching) between the current prediction (e.g., the predicted samples within the current block generated from the currently selected L-shape) and the neighboring reconstruction (e.g., the reconstructed samples within one or more neighboring blocks). Top boundary matching means the comparison between the current top predicted samples and the neighboring top reconstructed samples, and left boundary matching means the comparison between the current left predicted samples and the neighboring left reconstructed samples. The L-shape candidate with the smallest boundary matching cost is selected for generating the derived DIMD intra angular modes of the current block.

In some embodiments, a pre-defined subset of the current prediction is used to calculate the boundary matching cost. N line(s) of top boundary within the current block and/or M line(s) of left boundary within the current block are used. Moreover, M and N could be further determined based on the current block size. In some embodiments, the boundary matching cost is calculated according to:

$$cost = {\sum }_{x = o}^{block width} ( \vert a * {P}_{x , 0} - b * {P}_{x , 1} - c * {R}_{x , - 1} \vert + \vert d * {R}_{x , - 1} - e * {P}_{x , 0} - f * {R}_{x , - 2} \vert ) + {\sum }_{y = o}^{block height} ( \vert g * {P}_{0 , y} - h * {P}_{1 , y} - i * {R}_{- 1 , y} \vert + \vert j * {R}_{- 1 , y} - k * {P}_{0 , y} - l * {R}_{- 2 , y} \vert ) \qquad ( 10 )$$

where the weights (a, b, c, d, e, f, g, h, i, j, k, l) can be any positive integers or equal to 0. The following are examples of possible weights:

$$a = 2 , b = 1 , c = 1 , d = 2 , e = 1 , f = 1 , g = 2 , h = 1 , i = 1 , j = 2 , k = 1 , \\ l = 1$$

$$a = 2 , b = 1 , c = 1 , d = 0 , e = 0 , f = 0 , g = 2 , h = 1 , i = 1 , j = 0 , k = 0 , \\ l = 0$$

$$a = 0 , b = 0 , c = 0 , d = 2 , e = 1 , f = 1 , g = 0 , h = 0 , i = 0 , j = 2 , k = 1 , \\ l = 1$$

$$a = 1 , b = 0 , c = 1 , d = 0 , e = 0 , f = 0 , g = 1 , h = 0 , i = 1 , j = 0 , k = 0 , \\ l = 0$$

$$a = 2 , b = 1 , c = 1 , d = 2 , e = 1 , f = 1 , g = 1 , h = 0 , i = 1 , j = 0 , k = 0 , \\ l = 0$$

$$a = 1 , b = 0 , c = 1 , d = 0 , e = 0 , f = 0 , g = 2 , h = 1 , i = 1 , j = 2 , k = 1 , \\ l = 1 .$$

In some embodiments, more than one of the L-shapes can be used for HoG accumulation. These multiple L-shapes can be selected explicitly by signaling syntax element to select more than one L-shape. Implicit method for selecting multiple L-shapes by boundary matching may also be used. For example, if three L-shapes selected, the three L-shapes with lowest, second lowest and third lowest boundary matching costs can be chosen for HoG accumulation.

For some embodiments, the DIMD HoG accumulation and the intra prediction generation process are orthogonal. DIMD HoG accumulation can be done with the nearest L-shape of CU, while intra prediction generation may refer to multiple L-shapes. If multiple L-shapes for DIMD HoG accumulation and for intra prediction generation are both applied, the selected index or indices of the L-shape(s) can be carried from HoG accumulation process to prediction generation process. The generated prediction corresponding to the selected index or indices of the L-shape(s) can be reused in the prediction generation process. In some embodiment, if the index selected in first intra mode generation process is K, the index used for generating the prediction can have a predefined relationship to K. For example, the index for prediction generation can be one of the following indices, K−1, K, K+1.

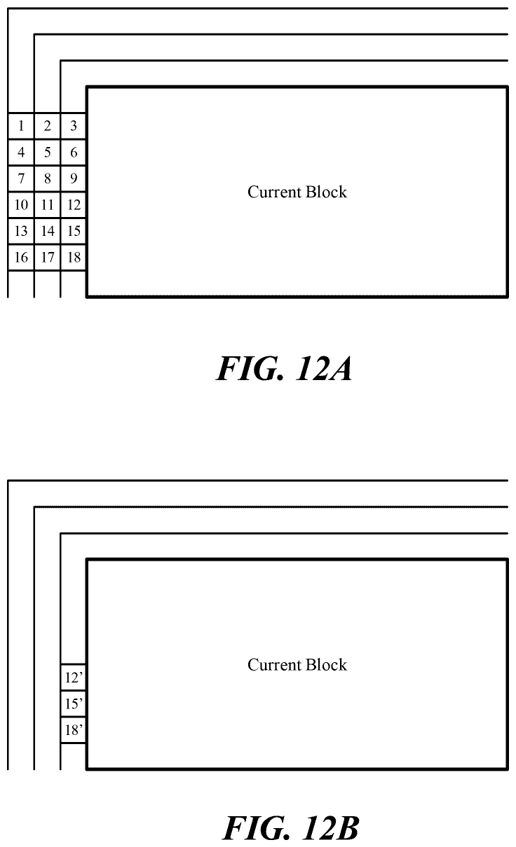

In some embodiments, instead of applying the Sobel filter on multiple L-shapes to accumulate the HoG, the neighboring pixels are fused together initially to generate new representative L-shapes. FIGS. 12A-B illustrate fusion of pixels neighboring a coding unit (CU). FIG. 12A shows the pixels neighboring the CU labeled 1 to 18. FIG. 12B shows fused pixels labeled 12′ and 18′. The fused pixels can be generated according to the following:

$${12}^{′} = ( 10 + 11 + 12 ) / 3$$

$${12}^{′} = ( 4 + 8 + 12 ) / 3$$

$${12}^{′} = ( 16 + 14 + 12 ) / 3$$

$${18}^{′} = ( 1 + 4 + 8 + 11 + 15 + 18 )$$

A fused L-shape reference line can be generated by applying filtering process on each of the neighborhood positions of the pixels. This filtering processing can reduce the noise and enhance the strength along certain direction. The original HoG accumulation process described in Section II above can be applied to derive the two DIMD intra modes based on at least one fused reference line (or up to three fused reference lines.)

When DIMD is used for the current block, two intra modes with the two highest gradient values are determined from the reconstructed neighboring samples, and the predictions of these two intra modes are further combined with the planar mode predictor with weights to produce the final intra predictor. When deciding the first two intra modes, the gradient of each intra modes is compared with the current best and the second best intra modes. However, if the gradient of the current candidate intra mode is the same as or very close within a threshold to the current best and/or the second best intra modes, it could further compare the TIMD cost of the current intra prediction mode and the current best and/or the second best intra modes. For example, if the current candidate intra mode has the same gradient magnitude as or very close gradient magnitude within a threshold to the current best and/or the second best intra modes, the template cost of the candidate intra modes are calculated as the SATD between the prediction and the reconstruction samples of the template. If the current candidate intra mode has lower template cost than the current best and/or the second best intra modes, the current candidate intra mode is selected as the current best or the second best intra mode.

In some embodiments, after the DIMD HoG is built, at most K candidate intra modes with the highest gradient values are selected. The video coder then applies TM to these candidate intra modes to decide the final 2 intra modes as the DIMD intra modes. For example, K can be set as five and TM cost is calculated with these five candidates who have highest gradient values. If non-zero bin number of the HoG is smaller than K, TM is calculated for the available non-zero bins. In some embodiments, a fixed number K is utilized to simplify hardware implementation for design elaboration.

In some embodiments, the DIMD process as described by Section II above can be used for the first pass selection to generate the two angular mode candidates with highest and second highest gradient values. TM is then applied for the second pass selection to refine the intra mode. Assuming the two intra modes from the DIMD process are M and N. TM is then applied to the intra modes {M−1, M, M+1}, and {N−1, N, N+1} for refining the two intra modes of DIMD. After refinement, the two DIMD intra modes may become the same one. For keeping the mode number as two, a predefined rule can be applied to select a second intra mode. For example, selecting from the list {M, N, M−1, M+1, N−1, N+1} as the second DIMD intra mode that is different than the refined first DIMD intra mode.

In some embodiments, HoG bin values and TM costs are fused as the final evaluation means to select the intra DIMD modes. The following shows one possible fusion formula:

$$Final evaluation value = HoG bin value + clamp ( ( 1 / TM cost ) * S , C )$$

where clamp (V, C)=V>C?C:V; S is a scaling factor

The final evaluation value incorporates the original HoG bin value and a clamped value which is proportional to the scaled version of the inversion of the TM cost. With this method, the DIMD intra modes are generated by jointly considering the HoG bin value and TM cost.

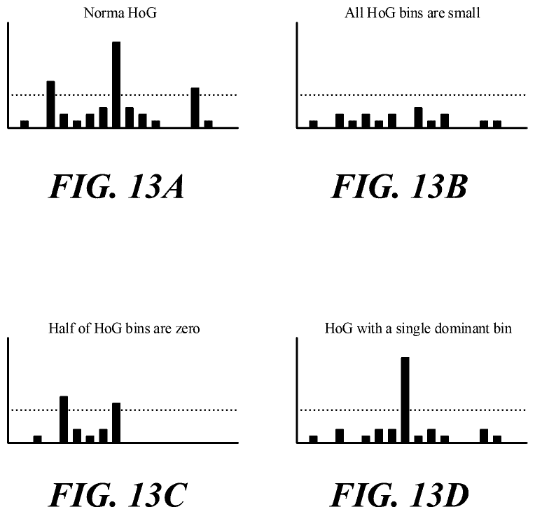

In some embodiments, the characteristics of the HoG are used for modifying the process of intra MPM construction. FIGS. 13A-D illustrate several different types of HoGs having different characteristics. FIG. 13A shows a HoG with a horizon threshold (TH) of the bin value. For a normal HoG, there are some bin values greater than the TH whereas some bin values are smaller than the TH. For this type of HoG, the final two DIMD modes comes from a wide span of the intra modes. FIGS. 13B-D are three special cases of the HoG, where the mode diversity of the HoG is constrained. In FIG. 13B, all bin values are smaller than TH. For this case, the DIMD intra modes in the MPM list can be reduced from two to one or from two to zero when constructing the MPM. In the way, other intra modes can be included in the MPM list and extra coding gain is attained. In FIG. 13C, half of the HoG's bin values are zero or almost zero, therefore the MPM list can be altered with this condition with fewer DIMD intra modes utilized. In FIG. 13D, there is only one dominant bin of the HoG, only this dominant DIMD intra mode is kept when constructing MPM and the DIMD intra modes are reduced from two to one. In addition to modifying the number of DIMD intra modes when constructing MPM according to special HoG characteristics, the remaining intra modes used to fill the intra MPM list can be specially selected for further boosting the coding gain. Table 2-1 below shows an example implementation for filling the intra MPM list:

TABLE 2-1

| | Remaining intra modes to be inserted in MPM |
|---|---|
| Normal HoG | DC_IDX, VER_IDX, HOR_IDX, VER_IDX − 4, VER_IDX + 4, 14, 22, |
| | 42, 58, 10, 26, 38, 62, 6, 30, 34, 66, 2, 48, 52, 16 |
| All small bins HoG | DC_IDX, VER_IDX, HOR_IDX, VER_IDX − 4, VER_IDX + 4, 2, 10, |
| | 16, 26, 34, 42, 48, 58, 66, 6, 14, 22, 30, 38, 52, 62 |
| Upper half zero HoG | DC_IDX, 18, 16, 20, 14, 22, 12, 24, 10, 26, 8, 28, 6, 30, 4, 32, 2, 34, 36, |
| | 38, 40 |
| Lower half zero HoG | DC_IDX, 50, 48, 52, 46, 54, 44, 56, 42, 58, 40, 60, 38, 62, 36, 64, 34, |
| | 66, 32, 30, 28, 26 |
| Dominant HoG | DC_IDX, D, D − 1, D + 1, D − 2, D + 2, D − 3, D + 3, . . . |

In some embodiments, 3 HoGs are built, (a left side HoG, an above side HoG, and the original left above side HoG.) From each HoG, the two DIMD modes are derived. In some embodiments, to decide the final DIMD modes, these three mode combinations (DIMD first and second modes for the 3 HoGs) are sent to a high-complexity RDO process to calculate a cost. Extra syntax elements are added in the bitstream to indicate which side (left/above/left and above) is used for HoG accumulation to derive the DIMD intra modes. In some other embodiments, to decide the final DIMD modes, TM costs of the three mode combinations (DIMD first and second modes for the 3 HoGs) are evaluated to decode which side (left/above/left and above) is used for HoG accumulation to derive the DIMD intra modes. For example, the TM costs of the first mode (of the three HoGs), can be used to select the side whose TM cost is lowest. Other cost evaluation methods can be used, such as using TM costs of the (weighted) sum of the first and second modes of the three HoGs to make a final selection among the 3 HoGs for HoG accumulation. In this way, additional coding gain is attained without extra syntax elements.

In some embodiments, with the above mentioned explicit HoG side or implicit HoG side selection, the selectable DIMD modes related to the different HOG sides are different. Table 2-2 shows an example implementation:

TABLE 2-2

| DIMD HoG side | Selectable intra modes |
|---|---|
| Left + Above | 2, 3, 4, 5, . . . , 64, 65, 66 |
| Left | 2, 3, 4, 5, . . . , 33, 34, 35 |
| Above | 33, 34, 35, . . . , 64, 65, 66 |

With the mode selection constraint, higher chances that the DIMD modes derived from the HoG of left side are different from the DIMD modes derived from the HoG of above side. In Table 2-2, there are some overlap of the selectable modes of left and above sides. Therefore, there is still opportunity for left and above HoG to derive the same DIMD intra modes. In some embodiments, Table 2-3 below is used and the intra modes derived from left and above sides are distinct.

TABLE 2-3

| DIMD HoG side | Selectable intra modes |
|---|---|
| Left + Above | 2, 3, 4, 5, . . . , 64, 65, 66 |
| Left | 2, 3, 4, 5, . . . , 32, 33, 34 |
| Above | 35, 36, 37, . . . , 64, 65, 66 |

To decide which table to use, the video coder in some embodiments may compress a video database to check the coding gain and select a predefined table for coding. In some embodiments, a set of possible tables are defined to be used by the video coder to signal syntax elements to select the best table for coding.

In some embodiments, with above-mentioned explicit HoG side or implicit HoG side selection, the selectable of the DIMD modes relating to each side are different. Table 2-4 shows an example implementation.

TABLE 2-4

| | Selectable intra modes in 131 |
|---|---|
| DIMD HoG side | angular modes domain |
| Left | 2, 6, 10, 14, 18, 22, . . . , 130 |
| Above | 4, 8, 12, 16, 20, 24, . . . , 128 |
| Left + Above | 3, 5, 7, 9, 11, 13, . . . , 131 |

In Table 2-4, for DIMD that is applied in 131 intra angular mode domain, the left-side HoG is used to derive the two intra modes from only (4×i+2) intra modes, where i=0 . . . 32, the right-side HoG is used to derived the two intra modes from only (4×j+4) intra modes, where j=0 . . . 32, and the left+above HoG is used to derive the two intra modes from only (2×k+3) intra modes, where k=0 . . . 64.

In some embodiments, with above-mentioned explicit HoG side or implicit HoG side selection, the selectable of the DIMD modes relating to each side are different. Table 2-5 shows an example implementation:

TABLE 2-5

| | Selectable intra modes in 67 |
|---|---|
| DIMD HoG side | angular modes domain |
| Left | 2, 6, 10, 14, 18, 22, . . . , 66 |
| Above | 4, 8, 12, 16, 20, 24, . . . , 64 |
| Left + Above | 3, 5, 7, 9, 11, 13, . . . , 65 |

In some embodiments, if the HoG bin values are all zero, the default DIMD intra modes are assigned to planer mode in current DIMD algorithm. To further increase the coding gain, this default mode can be changed to DC mode. In some embodiments, if the HoG bin values are all zero, the default DIMD intra modes are assigned to planer mode in current DIMD algorithm. For further increase the coding gain, this default mode can be switched to DC mode depending on a control flag signaled in SPS or PPS or PH or SH.

In some embodiments, if the HoG bin values are all zero, the default DIMD intra modes are assigned to planer mode in current DIMD algorithm. To further increase the coding gain, this default mode can be switched between planer mode and DC mode according to recent reconstructed pictures or reconstructed neighborhood pixels without extra signaling. Decoders have the reconstructed pictures or reconstructed neighborhood to decide whether the default mode should be switched between planer mode and DC mode.

In some embodiments, the two DIMD intra modes are also used for intra MPM list generation. If TM process is applied for DIMD intra mode decision, the computation burden for the decoder may increase drastically. Therefore, in certain embodiment, for decoder side complexity reduction when applying DIMD mode derivation for constructing the MPM list, the complex derivation process such as TM, non-adjacent L-shape selection are discarded. Only when the CU is coded with DIMD mode, the complex DIMD derivation process is enabled.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

### X. Prediction Based on Multiple Reference Lines

### A. Using Non-Adjacent Reference Lines

In a prediction scheme, the reference samples of the current block (e.g., neighboring predicted and/or neighboring reconstructed samples of the current block) are adjacent to the left and/or top boundary of the current block. Some embodiments provide methods for improving accuracy for cross-component prediction and/or intra/inter prediction by using non-adjacent reference samples (neighboring predicted and/or neighboring reconstructed samples that are not adjacent to the boundary of the current block) as (i) the reference samples to generate the prediction of the current block and/or (ii) the reference samples to determine the intra prediction mode of the current block.

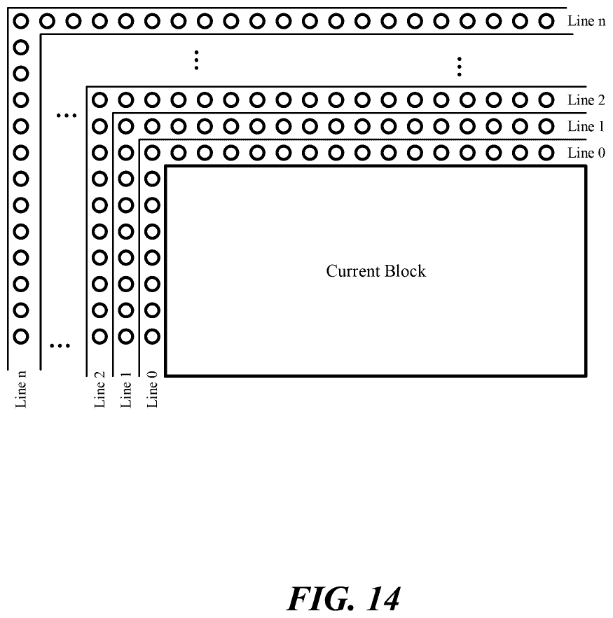

FIG. 14 illustrates adjacent and non-adjacent reference lines and reference samples of the current block. Line 0 is a reference line having reference samples that is adjacent to the current block. Lines 1 and 2 are the non-adjacent reference lines having reference samples that are not adjacent to the current block. In some embodiments, the non-adjacent reference samples are not limited to lines 1 and 2. In some embodiments, the non-adjacent reference samples may be any extended non-adjacent reference lines (such as line n where n is a positive integer number such as 1, 2, 3, 4, and/or 5). In some embodiments, the non-adjacent reference samples may be any subset of samples in each of the selected one or more non-adjacent reference lines.

In some embodiments, a flag (e.g., SPS flag) is signaled to indicate that, in addition to the adjacent reference line (used in the traditional prediction), whether to allow one or more non-adjacent reference lines as the candidate reference lines of the current block. In some embodiments, the candidate reference lines for the current block may include adjacent reference line (e.g., line 0) and one or more non-adjacent reference lines (e.g., lines 1 through N). In some embodiments, the candidate reference lines for the current block include only one or more non-adjacent reference lines and not the adjacent reference line.

In some embodiments, an implicit rule is used to indicate that, in addition to the adjacent reference line, whether to allow one or more non-adjacent reference lines as the candidate reference lines of the current block. In some embodiments, the implicit rule may depend on the block width, height, area, mode information from other color components, or mode information of the neighboring blocks. In some embodiments, when the current block area is smaller than a pre-defined threshold, only the adjacent reference lines can be used to generate the intra prediction of the current block. In some embodiments, when most of the neighboring blocks (e.g., the top and left neighboring blocks) use one or more non-adjacent reference lines, in addition to the adjacent reference line, non-adjacent reference lines can be the candidate reference lines for the current block. In some embodiments, when most of the neighboring blocks (e.g., the top and left neighboring blocks) use one or more non-adjacent reference lines, only non-adjacent reference lines can be the candidate reference lines for the current block. In some embodiments, the reference line selection of the current color component is based on the reference line selection of other color components.

In some embodiments, the non-adjacent reference lines may refer to only lines 1 and 2 or only any subset of lines 1 and 2, only lines 1 through 5 or any subset of lines 1 through line 5, or any subset of lines 1 through n, where n is a positive integer and when the current encoding/decoding component is a chroma component (e.g., Cb, Cr). In other words, for a chroma component, in addition to line 0 (the adjacent reference line), any combination or subsets of the non-adjacent reference lines can be used as the candidate reference lines for the current block.

### B. Chroma Prediction Based on MRL

A chroma block may refer to a chroma CB belonging to a CU that includes luma and/or chroma CBs. A chroma block may be in the intra slice/tile. A chroma block may be split from dual tree splitting. In some embodiments, in addition to using multiple candidate reference lines for chroma prediction based on LM modes, multiple candidate reference lines can also be used for chroma prediction based on non-LM (not related to linear model) methods.

In some embodiments, when the current block is coded with an intra prediction mode, one or more reference lines are selected from multiple candidate reference lines. (The intra prediction mode can be DIMD chroma mode, chroma DM, an intra chroma mode in the candidate list for chroma MRL, DC, planar, or angular modes, or which can be selected from 67 intra prediction modes, or which can be any mode from extended 67 intra prediction modes such as 131 intra prediction modes. For Chroma DM mode, the intra prediction mode of the corresponding (collocated) luma block covering the center position of the current chroma block is directly inherited.)

In some embodiments, the candidate list for chroma MRL includes planar, vertical, horizontal, DC, LM modes, chroma DM, DIMD chroma mode, diagonal (DIA), vertical diagonal (VDIA) (mode 66 in 67 intra prediction modes) or any subset of the above. For example, the candidate list for chroma MRL may include planar (changed to VDIA if duplicated with chroma DM), vertical (changed to VDIA if duplicated with chroma DM), horizontal (changed to VDIA if duplicated with chroma DM), DC (changed to VDIA if duplicated with chroma DM), 6 LM modes, chroma DM. For another example, the candidate list for chroma MRL includes planar (changed to VDIA if duplicated with chroma DM), vertical (changed to VDIA if duplicated with chroma DM), horizontal (changed to VDIA if duplicated with chroma DM), DC (changed to VDIA if duplicated with chroma DM), chroma DM. For another example, the candidate list for chroma MRL includes 6 LM modes, chroma DM.

In some embodiments, when the current block is a chroma block and DIMD chroma mode (as described in Section VI above) is used for the current block, reference line 0/1/2 of FIG. 14 are used to calculate HoG (line 1 is the center line for calculating HoG). In some embodiments, an indication is used to decide the center line from one or more candidate center lines. For example, if the indication specifies that the center line is line 2, then reference lines 1, 2, and 3 are used to calculate HoG.

In some embodiments, the indication is explicitly signaled in the bitstream. The indication may be coded using truncated unary codewords to select among candidate center lines 2, 3, or 4. For example, line 2 is represented by codeword 0, line 3 is represented by codeword 10, and line 4 is represented by codeword 11. In some embodiments, the candidate center lines always include the default center line (e.g., reference line 1). In some embodiments, the candidate center lines are predefined based on explicit signaling. For example, a flag is signaled to decide whether to use the default center line or not. If the flag indicates not to use the default center line, an index is further signaled to select the center line from one or more candidate center lines (excluding the default center line).

In some embodiments, the candidate center lines are predefined based on an implicit rule. For example, when the current block is larger than a threshold, the candidate center lines include lines k, where k is larger than the line number of the default center line.

In some embodiments, when the current block is a chroma block and one or more non-adjacent lines are used for the current block to generate prediction, a flag is signaled to indicate whether to use DIMD chroma mode for the current block. If the flag indicates to use DIMD chroma mode for the current block, an index is further signaled to select the center line (for e.g., calculating HoG; for DIMD chroma mode, the center line is line 1) from one or more candidate center lines excluding the default center line. In some embodiments, the default center line means the center line used for DIMD chroma mode when the adjacent line is used for the current block to generate prediction. In some embodiments, the center line used for DIMD chroma mode to calculate HoG affects the reference line used to generate prediction for the current block. In some embodiments, the center line is used as the reference line to generate prediction for the current block.

In some embodiments, the line located at an offset from the position of center line is used as the reference line to generate prediction for the current block. For example, if the center line is line 2 and the offset is 1, line 3 is used as the reference line. For another example, if the center line is line 2 and the offset is −1, line 1 is used as the reference line. For another example, for DIMD chroma mode described in Section VI, the center line is line 1.

In some embodiments, the center line used for DIMD chroma mode to calculate HoG has no influence on the reference line used to generate prediction for the current block. In some embodiments, when the center line is different from the default center line (e.g., line 1), the reference line to generate the prediction for the current block is fixed by using a pre-defined reference line. For example, the pre-defined reference line is the adjacent reference line.

In some embodiments, multiple DIMD chroma modes are generated by changing the center line of HoG generation. The template matching costs for these intra modes are calculated. The intra mode with the lowest template matching cost is used to decide the final center line of the HoG generation for both the encoding and decoding processes. In some of these embodiments, syntax elements for selecting a non-default DIMD chroma center line of the HoG generation are not signaled.

In some embodiments, the original process for the DIMD chroma mode derivation adopts both luma and chroma information for the HoG generation. For generating the HoG with the non-default center line, the contribution from luma is removed and only chroma is used for HoG generation for deriving the DIMD chroma mode. In some embodiments, in addition to eliminating the contribution to HoG from luma when deriving the DIMD chroma mode with non-default center line. The contribution to HoG from luma when deriving the DIMD chroma mode with default center line is also removed.

In some embodiments, the corner of the L-shape is removed for the HoG generation. In some embodiments, for reducing the computation of HoG, the gradients from the top and left corner positions are eliminated from HoG accumulation. This elimination can be applied based on certain judgement on block size, or always applied. For example, if the current block width plus current block height or the current block area is greater than a predefined threshold, the gradients from these corner positions are discarded, that is, only the gradients from above-side and left-side are included in HoG computation.

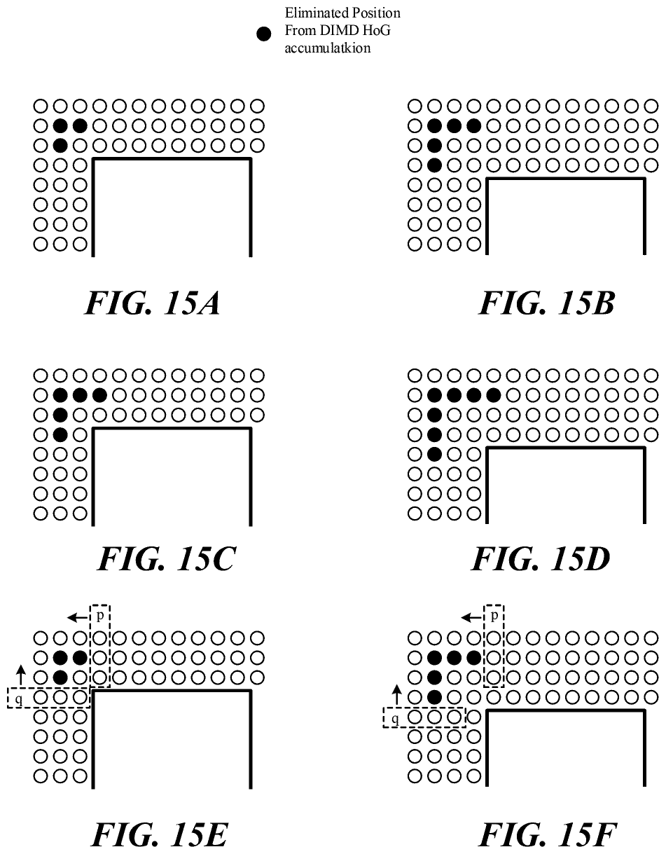

FIGS. 15A-F show elimination of corner of L-shapes reference lines for DIMD HoG computation. FIGS. 15A-B show one type (type 0) of the corner elimination. FIG. 15A show the corner elimination when center line is line 1. FIG. 15B shows corner elimination when the center line is line 2. This can reduce the complex of the HoG generation and the coding gain is maintained without serious degradation.

In some embodiments, two more corner positions are removed from the HoG generation (denoted as type 1 in the FIGS. 15C-D). The gradient calculation of the HoG generation process involves two 3×3 Sobel filters. The 3×3 neighboring pixels are required for the gradient calculation. With further removal of the extra two positions, the HoG generation only depends on the pixels from above and left CUs. The dependency to the pixels of above-left CU is removed. With this modification, the implementation of the DIMD chroma mode derivation is simplified, especially when it comes to hardware implementation situation.

In some embodiments, pixel padding is used when calculating the gradients for the positions adjacent to the removed positions. FIG. 15E shows HoG center line is 1. FIG. 15F shows HoG center line is 2. The pixels denoted by “p” are padded left before gradient calculation. Whereas the pixels denoted by “q” are padded to above before gradient calculation. In this way, the number of removed positions for HoG generation is the same as the corner elimination of type 0 while the HoG dependency to the above-left CU is also removed similar to the corner elimination of type 1.

The above-mentioned corner elimination types can be applied to both luma and chroma HoG generation. The corner elimination may also be applied to a single component, i.e., applied to only luma or only chroma.

In some embodiments, after the intra mode derived by the DIMD chroma intra mode derivation process has been decided with certain non-default center line of the HoG generation. The prediction is generated with this derived intra mode where the selected line for generating the prediction can be either dependent or independent of the center line of the HoG generation. This prediction can be further blended with other intra coding methods that also generate the predictions of the current CU. A flag can be signaled to indicate whether the blending process is activated. In addition, the blending weights of the involved predictions are signaled if the blending process is activated. For the simplest case, where only two predictions are involved in the blending process. For more complex cases, more than two predictions may be involved in this blending process. In some embodiments, the blending process is always enabled such that the flag for indicating the activation of blending is eliminated. In some embodiments, the activation of the blending process can be implicitly inferred by the available coding information and/or the pixels of the neighboring CUs. Therefore, the flag for indicating the activation of blending is eliminated. In some embodiment, the weights of the blending process are predefined or can be implicitly inferred by the available coding information and/or the pixels of the neighboring CUs. Therefore, the signaling of the blending weights is eliminated.

In some embodiments, when referencing neighboring samples to generate intra prediction, only one reference line is used, and the one reference line is selected from multiple candidate reference lines. In some embodiments, when referencing neighboring samples to generate intra prediction, multiple reference lines are used. In some embodiments, whether to use only one reference line or multiple reference lines depends on an implicit rule. The implicit rule depends on block width, block height, or block area. For example, when the block area, block width, or block height is smaller than a predefined threshold, only one reference line is used when generating intra prediction. The threshold can be any positive integer such as 2, 4, 8, 16, 32, 64, 128, 256, 512, 1024, . . . , or the maximum transform size. For another example, the implicit rule may depend on the mode information of the current block such as the intra prediction mode for the current block. For example, when the current intra prediction mode has non-integer predicted samples (referring to the samples located at non-integer position), more than one reference lines are used for generating intra prediction. Further example, when the current intra prediction mode may need intra interpolation filter to generate intra prediction since one or more predicted samples may fall into a fractional or integer position between reference samples according to a selected direction (by the current intra prediction mode).

For another example, the implicit rule depends on the mode information of the previous coded blocks such as the intra prediction mode for the neighboring block, the selected reference line for the neighboring block. In some embodiments, the video coder may use only one reference line or multiple reference lines based on an explicit syntax. In some embodiments, when referencing neighboring samples to generate intra prediction, more than one reference lines are used.

### C. Blending Multiple Reference Lines

In some embodiments, when more than one reference lines are used to generate intra prediction for the current block, a MRL blending process is used. In some embodiments (“first version”), each used reference line is used to generate a prediction and then a blending process is applied to blend multiple hypotheses of predictions from multiple used reference lines. Alternatively, in some embodiments (“second version”), a blending process is applied to blend each used reference line and the blended reference line is used to generate intra prediction. In some embodiments, when the MRL blending process is applied, the fusion of chroma intra prediction modes is disabled (or inferred to be disabled). In some embodiments, when fusion of chroma intra prediction modes is applied, the MRL blending process is disabled.

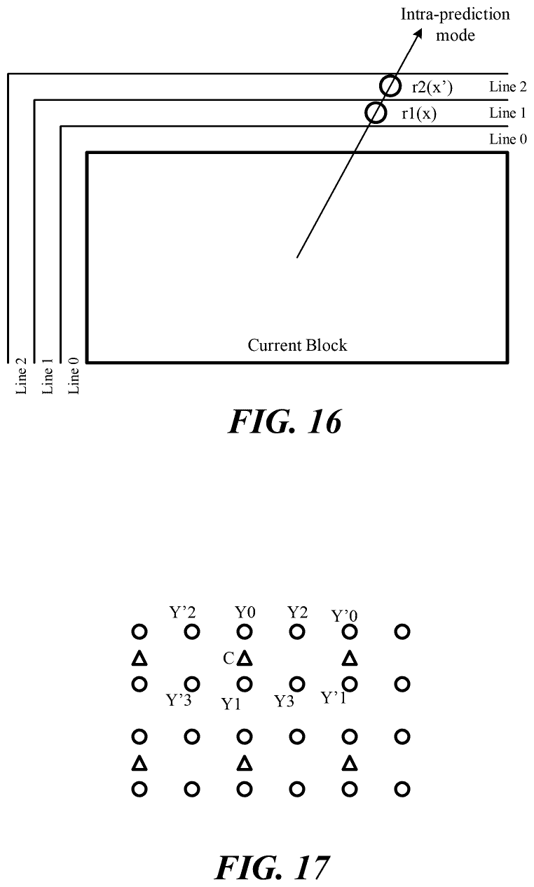

In some embodiments, when blending the reference lines, the intra prediction mode is considered. FIG. 16 shows blending of reference lines based on intra prediction mode. As illustrated, when the intra prediction mode is an angular mode the location (x) of to-be-blended sample (r1) in one reference line and the corresponding location (x′) of to-be-blended sample (r2) in another reference line based on the intra prediction mode. When the intra prediction mode is not an angular mode such as DC or planar, the location (x) of to-be-blended sample (r1) in one reference line and the corresponding location (x′) of to-be-blended sample (r2) in another reference line are the same.

Alternatively, in some embodiments, when blending the reference lines, the intra prediction mode is not considered. When the intra prediction mode is an angular mode, the location (x) of to-be-blended sample (r1) in one reference line and the corresponding location (x′) of to-be-blended sample (r2) in another reference line are the same.

For example, when two reference lines are used, the final prediction for the current block may be formed by weighted averaging of a first prediction from the first reference line and a second prediction from the second reference line. (Alternatively, the final prediction for the current block may be formed by the prediction from a weighted averaging of the first reference line and the second reference line.)

In some embodiments, the weighting of MRL blending is predefined with an implicit rule. For example, the weighting may be fixed as (w1, w2)=any one of (3, 1), (3, 1), (2, 2) where w1 is the weight for the first reference line and w2 is the weight for the second reference line. Since the summation of w1 and w2 is 4, right shifting by 2 is applied after adding the predicted samples from the first and second reference lines. (If the MRL blending process is performed by weighted averaging of reference lines, the process may apply right shifting by 2 after adding the first and second reference lines.) In some embodiments, the implicit rule may depend on current block width, height, area, the mode information or width or height of the neighboring blocks. In some embodiments, the weighting may be indicated with explicit syntax.

### D. Signaling MRL Combination Selection for Intra Prediction

Some embodiments of the disclosure provide a MRL combination selection/signaling method for intra-prediction. In some embodiments, an index is signaled to indicate a selected combination for the current block and a combination refers to an intra prediction mode, a first reference line, and a second reference line. (The first reference line and the second reference line in the signaled combination may be used to generate a fused or blended reference line according to the previous section.) In some embodiments, the index is signaled by using truncated unary codewords. In some embodiments, the index is signaled with contexts. In some embodiments, the mapping from the index to the selected combination is based on boundary/template matching, by calculating the boundary/template matching cost for each candidate combination according to the following steps:
Step 0: If boundary matching is used, for each candidate combination, the prediction for the current block is the blended prediction from multiple hypotheses of prediction by the first reference line (based on the intra prediction mode) and the second reference line (based on the intra prediction mode). In some embodiments, for each candidate combination, the prediction for the current block is the prediction from the blended or fused reference line of the first and second reference lines (based on the intra prediction mode). If template matching is used, for each candidate combination, the prediction on the template is the blending prediction from multiple hypotheses of prediction by the first reference line (based on the intra prediction mode) and the second reference line (based on the intra prediction mode). If the candidate combination is line 1 and line 2 and the template width and height are equal to 1, line 1 will be the reference line adjacent to the template and line 2 will be the reference line adjacent to line 1. In some embodiments, for each candidate combination, the prediction for the template is the prediction from the blended reference line based on the first and second reference lines (based on the intra prediction mode).
Step1: The signalling of each combination follows the order of the costs in Step0. The index equal to 0 is signalled with the shortest or most efficient codewords and maps to the pair with the smallest boundary/template matching cost. Encoder and decoder may perform Step0 and Step1 to obtain the same mapping from the signaled index to the combination.

In some embodiments, the number of the candidate combinations for signalling can be reduced from original total candidate combinations to the first K candidate combinations with the smallest costs and the codewords for signalling the selected combination can be reduced. When K is set as 1, the selected combination can be inferred as the combination with the smallest cost without signalling the index. For chroma MRL, the candidate intra prediction modes may include planar (changed to VDIA if duplicated with chroma DM), vertical (changed to VDIA if duplicated with chroma DM), horizontal (changed to VDIA if duplicated with chroma DM), DC (changed to VDIA if duplicated with chroma DM), chroma DM and 6 LM modes and the candidate reference lines include line 0, 1, 2 (with the first reference line as line n and the second reference line as line n+1). The total number of candidate combinations may be 11*3, the video coder may use only the first K combination with the smallest costs as the candidate combinations for signalling, where K can be a positive integer such as 1, 2, 3, or 32. In some embodiments, when the boundary/template of the current block is not available, a default combination (e.g., any one of candidate intra prediction modes, any one pair from the candidate reference lines) is defined and used. In some embodiments, when the boundary/template of the current block is not available, chroma MRL is inferred as disabled.

In some embodiments, the intra-prediction MRL combination signaling scheme described above is applied when multiple reference lines (which can include the adjacent reference line and/or one or more non-adjacent reference lines) are used for generating intra prediction of the current block. In some embodiments, whether to use the intra-prediction MRL combination signaling scheme may depend on a signaling syntax or an implicit rule to be enabled or disabled, and when the intra-prediction MRL combination signaling scheme is disabled, an alternative signaling scheme (e.g., as specified by VVC) for the intra prediction and/or reference line may be followed.

In some embodiments, an index is signaled to indicate the selected combination for the current block and a combination refers to an intra prediction mode, the first reference line, the second reference line, and the weighting. In some embodiments, the index is signaled with truncated unary codewords. In some embodiments, the index is signaled with contexts. In some embodiments, the mapping from the index to the selected combination depends on boundary/template matching according to following steps:
Step0: The boundary/template matching cost for each candidate combination is calculated. If boundary matching is used, for each candidate combination, the prediction for the current block is the blending prediction from multiple hypotheses of predictions by the first and second reference lines (based on the intra prediction mode) and the weighting. If template matching is used, for each candidate combination, the prediction on the template is the blending prediction from multiple hypotheses of predictions by the first and second reference lines, and the weighting. If the selected candidate pair of reference lines are reference lines 1 and 2, and the template width and height are equal to 1, line 1 is the reference line adjacent to the template and line 2 is the reference line adjacent to line 1.
Step1: The signaling of each combination follows the order of the costs in Step0. The index equal to 0 is signalled with the shortest or most efficient codewords and maps to the pair with the smallest boundary/template matching cost. The encoder and the decoder may perform Step0 and Step 1 to obtain the same mapping from the signalled index to the combination.

In some embodiments, the number of the candidate combinations for signalling can be reduced from original total candidate combinations to the first K candidate combinations with the smallest costs and the codewords for signalling the selected combination can be reduced. When K is set as 1, the selected combination can be inferred as the combination with the smallest cost without signalling the index. For chroma MRL, the candidate intra prediction modes may include planar (changed to VDIA if duplicated with chroma DM), vertical (changed to VDIA if duplicated with chroma DM), horizontal (changed to VDIA if duplicated with chroma DM), DC (changed to VDIA if duplicated with chroma DM), chroma DM and 6 LM modes and the candidate reference lines include line 0, 1, 2 and the candidate weightings (w1, w2), such as (1, 3), (3, 1), (2, 2). The video coder may use only the first K combination with the smallest costs as the candidate combinations for signalling, where K can be a positive integer such as 1, 2, 3. In some embodiments, when the boundary/template of the current block is not available, a default combination (e.g., any one of candidate intra prediction modes, any one pair from the candidate reference lines) is defined and used. In some embodiments, when the boundary/template of the current block is not available, chroma MRL is inferred as disabled.

In some embodiments, a first index is signaled to indicate the first reference line and a second index is signaled to indicate the second reference line. The signaling of the second index depending on the first reference line. (The total available candidate reference lines include lines 0, 1, and 2.) In some embodiments, the first reference line=the first index (ranging from 0 to 2), and the second reference line=the second index (ranging from 0 to 1)+1+the first index. For some embodiments, the first reference line cannot be the same as the second reference line. In some embodiments, the first index is signalled to indicate the first reference line. The second reference line is inferred according to the first reference line. In other words, an index is signalled to decide a pair of the first and second reference lines. In some embodiments, the second reference line is the reference line adjacent to the first reference line.

More generally, the first reference line is line n and the second reference line is line n+1. For some embodiments, if line n+1 exceeds the farthest reference line allowed for the current block (such as line 2 if only line 0, 1, 2 are the candidate reference lines of the current block), the second reference line cannot be used. In some embodiments, the first reference line is line n and the second reference line is line n-1. If n is equal to 0, the second reference line cannot be used. In some embodiments, the mapping from the index to the selected reference line pair depends on boundary/template matching according to the following steps:
Step0: The boundary/template matching cost for each candidate reference line pair is calculated. If boundary matching is used, for each candidate pair, the prediction for the current block is the blending prediction from multiple hypotheses of prediction by the first reference line and the second reference line. If template matching is used, for each candidate pair, the prediction on the template is the blending prediction from multiple hypotheses of prediction by the first reference line and the second reference line. If the pair equal to line 1 and line 2 is a candidate pair and the template width and height are equal to 1, line 1 is the reference line adjacent to the template and line 2 is the reference line adjacent to line 1.
Step1: The signalling of each pair follows the order of the costs in Step0. The index equal to 0 is signalled with the shortest or most efficient codewords and maps to the pair of reference lines with the smallest boundary/template matching cost. The encoder and the decoder perform Step0 and Step 1 to obtain the same mapping from the signalled index to the pair. The number of the candidate pairs for signalling can be reduced to the first K candidate pairs with the smallest costs, and the codewords for signalling the selected pair can be reduced. In some embodiments, when the boundary/template of the current block is not available, a default pair of reference lines (e.g., lines 0 and 2, lines 0 and 1, lines 1 and 2) is defined and used as the first pair of reference lines. In some embodiments, when the boundary/template of the current block is not available, a default reference line (e.g., line 0) is defined and used as the first reference line and only the first reference line is used for generating intra prediction.

In some embodiments, the first reference line is implicitly derived and the second reference line is determined based on explicit signaling and the first reference line. For one example, the first reference line may be inferred as line 0, or the reference line with the smallest boundary matching or template matching cost. In some embodiments, when the boundary/template of the current block is not available, a default reference line (e.g., line 0) is defined and used as the first reference line. In some embodiments, when the boundary/template of the current block is not available, a default reference line is defined and used as the first reference line and only the first reference line is used for generating intra prediction.

In some embodiments, both the first reference line and the second reference line are implicitly derived. In some embodiments, the selected reference line pair is determined based on boundary/template matching according to the following steps:
Step0: The boundary/template matching cost for each candidate reference line pair is calculated. If boundary matching is used, for each candidate pair, the prediction for the current block is the blending prediction from multiple hypotheses of prediction by the first reference line and the second reference line. If template matching is used, for each candidate pair, the prediction of the template is the blending prediction from multiple hypotheses of prediction by the first reference line and the second reference line. If the pair of line 1 and line 2 is a candidate pair and the template width and height are equal to 1, line 1 may be the reference line adjacent to the template and line 2 may be the reference line adjacent to line 1.
Step1: The selected reference line pair is inferred as the pair with the smallest boundary/template matching cost. The encoder and the decoder may both perform Step0 and Step 1 to obtain the same selected the pair.

In some embodiments, when the boundary/template of the current block is not available, a default pair of reference lines (e.g., lines 0 and 2, lines 0 and 1, lines 1 and 2) is defined and used as the first pair of reference lines. In some embodiments, when the boundary/template of the current block is not available, a default reference line (e.g., line 0) is defined and used as the first reference line and only the first reference line is used for generating intra prediction. More generally, for a candidate reference line pair, if the first reference line is line n and the second reference line is line n+1, and if line n+1 exceeds the farthest reference line allowed for the current block (e.g., line 2 when only lines 0 through 2 are allowed), the second reference line cannot be used. For a candidate reference line pair, if the first reference line is line n, the second reference line is line n−1.

In some embodiments, when only one reference line is used to generate intra prediction for the current block, the selection of the reference line is based on an implicit rule. For example, in some embodiments, the selected reference line (among the candidate reference lines) is the one with the smallest boundary matching cost or the smallest template matching cost. In some embodiments, when the boundary/template of the current block is not available, a default reference line (e.g., line 0) is defined and used as the first reference line. In some sub-embodiments, an index is signaled to indicate the selected reference line for the current block. In some embodiments, an index is signaled to indicate the selected combination for the current block (a combination refers to an intra prediction mode and a reference line).

In some embodiments, the index is signaled by using truncated unary codewords. In some embodiments, the index is signaled with contexts. In some embodiments, the mapping from the index to the selected combination depends on boundary/template matching according to the following steps:
Step0: The boundary/template matching cost for each candidate combination is calculated. If boundary matching is used, for each candidate combination, the prediction for the current block is the prediction from the reference line (based on the intra prediction mode). If template matching is used, for each candidate combination, the prediction on the template is the prediction from the reference line (based on the intra prediction mode). If the reference line equal to line 1 is a candidate reference line and the template width and height are equal to 1, line I will be the reference line adjacent to the template and line 2 will be the reference line adjacent to line 1.
Step1: The signalling of each combination follows the order of the costs in Step0. The index equal to 0 is signalled with the shortest or most efficient codewords and maps to the pair with the smallest boundary/template matching cost. Encoder and decoder may both perform Step0 and Step 1 to obtain the same mapping from the signalled index to the combination.

In some embodiments, the number of the candidate combinations for signalling can be reduced from original total candidate combinations to the first K candidate combinations with the smallest costs and the codewords for signalling the selected combination can be reduced. When K is set as 1, the selected combination can be inferred as the combination with the smallest cost without signalling the index. For chroma MRL, the candidate intra prediction modes may include planar (changed to VDIA if duplicated with chroma DM), vertical (changed to VDIA if duplicated with chroma DM), horizontal (changed to VDIA if duplicated with chroma DM), DC (changed to VDIA if duplicated with chroma DM), chroma DM and 6 LM modes and the candidate reference lines include line 0, 1, 2 (with the first reference line as line n and the second reference line as line n+1).

The total number of candidate combinations may be 11*3 (for n=0, n=1 and n=2), but the video coder may use only the first K combinations with the smallest costs as the candidate combinations for signalling, where K can be a positive integer such as 1, 2, 3, or 22, or 33. In some embodiments, when the boundary/template of the current block is not available, a default combination (e.g., any one of candidate intra prediction modes, any one pair from the candidate reference lines) is defined and used. In some embodiments, when the boundary/template of the current block is not available, chroma MRL is inferred as disabled.

In some embodiments, the intra-prediction MRL combination signaling scheme described above is applied when multiple reference lines (which can include the adjacent reference line and/or one or more non-adjacent reference lines) are used for generating intra prediction of the current block. In some embodiments, the intra-prediction MRL combination signaling scheme described above is applied only when a non-adjacent reference line is used for generating the intra prediction of the current block. In some embodiments, whether to use the intra-prediction MRL combination signaling scheme may depend on a signaling syntax or an implicit rule to be enabled or disabled, and when the intra-prediction MRL combination signaling scheme is disabled, an alternative signaling scheme (e.g., as specified by VVC) for the intra prediction and/or reference line may be followed.

In some embodiments, boundary matching cost for a candidate is calculated. A boundary matching cost for a candidate mode may refer to the discontinuity measurement (including top boundary matching and/or left boundary matching) between the current prediction (the predicted samples within the current block), generated from the candidate mode, and the neighboring reconstruction (the reconstructed samples within one or more neighboring blocks). Top boundary matching means the comparison between the current top predicted samples and the neighboring top reconstructed samples, and left boundary matching means the comparison between the current left predicted samples and the neighboring left reconstructed samples. Boundary matching cost is described by reference to FIG. 11 above.

In some embodiments, a pre-defined subset of the current prediction is used to calculate the boundary matching cost, e.g., n line(s) of top boundary within the current block and/or m line(s) of left boundary within the current block may be used. (Moreover, n2 line(s) of top neighboring reconstruction and/or m2 line(s) of left neighboring reconstruction are used.) An example of boundary matching cost calculation is provided by Eq. (10) above. Another example of calculating a boundary matching cost (n=2, m=2, n2=1, m2=1) is provided according to the following:

$$cost = {\sum }_{x = o}^{block width} ( \vert a * {pred}_{x , 0} - b * {pred}_{x , 1} - c * {reco}_{x , - 1} \vert ) + {\sum }_{y = o}^{block height} ( \vert g * {pred}_{0 , y} - h * {pred}_{1 , y} - i * {reco}_{- 1 , y} \vert ) \qquad ( 11 )$$

where the weights (a, b, c, g, h, i) can be any positive integers such as a=2, b=1, c=1, g=2, h=1, i=1. Another example of calculating a boundary matching cost. (n=1, m=1, n2=2, m2=2):

$$cost = {\sum }_{x = o}^{block width} ( \vert d * {reco}_{x , - 1} - e * {pred}_{x , 0} - f * {reco}_{x , - 2} \vert ) + {\sum }_{y = o}^{block height} ( \vert j * {reco}_{- 1 , y} - k * {pred}_{0 , y} - l * {reco}_{- 2 , y} \vert ) \qquad ( 12 )$$

where the weights (d, e, f, j, k, 1) can be any positive integers such as d=2, e=1, f=1, j=2, k=1, 1=1. Another example of calculating a boundary matching cost. (n=1, m=1, n2=1, m2=1):

$$cost = {\sum }_{x = o}^{block width} \vert a * {pred}_{x , 0} - c * {reco}_{x , - 1} \vert + {\sum }_{y = o}^{block height} \vert g * {pred}_{0 , y} - i * {reco}_{- 1 , y} \vert \qquad ( 13 )$$

where the weights (a, c, g, i) can be any positive integers such as a=1, c=1, g=1, i=1. Another example of calculating a boundary matching cost. (n=2, m=1, n2=2, m2=1):

$$cost = {\sum }_{x = o}^{block width} ( \vert a * {pred}_{x , 0} - b * {pred}_{x , 1} - c * {reco}_{x , - 1} \vert + \vert d * {reco}_{x , - 1} - e * {pred}_{x , 0} - f * {reco}_{x , - 2} \vert ) + {\sum }_{y = o}^{block height} ( \vert g * {pred}_{0 , y} - i * {reco}_{- 1 , y} \vert ) \qquad ( 14 )$$

where the weights (a, b, c, d, e, f, g, i) can any positive integers such as a=2, b=1, c=1, d=2, e=1, f=1, g=1, i=1. Another example of calculating a boundary matching cost. (n=1, m=2, n2=1, m2=2)

$$cost = {\sum }_{x = o}^{b lock width} ( \vert a * {pred}_{x , 0} - c * {reco}_{x , - 1} \vert ) + {\sum }_{y = o}^{b lock height} ( \vert g * {pred}_{0 , y} - h * {pred}_{1 , y} - i * {reco}_{- 1 , y} \vert + \vert j * {reco}_{- 1 , y} - k * {pred}_{0 , y} - l * {reco}_{- 2 , y} \vert ) \qquad ( 15 )$$

where the weights (a, c, g, h, i, j, k, l) can any positive integers such as a=1, c=1, g=2, h=1, i=1, j=2, k=1, 1=1.

Other examples for n and m can also be applied to n2 and m2; n can be any positive integer such as 1, 2, 3, 4, etc., and m can be any positive integer such as 1, 2, 3, 4, etc. In some embodiments, n and/or m vary with block width, height, or area. In some embodiments, for a larger block (area>threshold2=65, 128, or 256), m becomes larger (2 or 4 instead of 1 or 2).

In some embodiments, for a larger block (area>threshold2=64, 128, or 256), n becomes larger (increase to 2 or 4 instead of 1 or 2). In some embodiments, for a taller block (height>threshold2*width), m becomes larger and/or n becomes smaller. Threshold2=1, 2, or 4. When height>threshold2*width, m is increased (e.g., to 2 or 4 instead of 1 or 2.) In some embodiments, for a wider block (width>threshold2*height), n becomes larger and/or m becomes smaller. Threshold2=1, 2, or 4. When width>threshold2*height, m is increased (e.g., to 2 or 4 instead of 1 or 2.)

For some embodiments, a template matching cost for a candidate may refer to the distortion (including top template matching and/or left template matching) between the template prediction (the predicted samples within the template), generated from the candidate, and the template reconstruction (the reconstructed samples within template). Top template matching means the distortion between the top template predicted samples and the top template reconstructed samples, and left template matching means the distortion between the left template predicted samples and the left template reconstructed samples. The distortion can be SAD, SATD, or any measurement matrix/methods for difference.

### E. Deriving Linear Model Based on Multiple Reference Lines

If chroma component or luma component of the current block has multiple neighboring reference lines (including the adjacent reference line and/or non-adjacent reference lines), neighboring samples may be used for deriving mode1 parameters of CCLM/MMLM. Such derivations of the linear models may be adaptive by reference line selection. In the example of FIG. 14, line 0 corresponds to the first reference line, line 1 corresponds to the second reference line, line 2 corresponds to the third reference line, etc. These multiple reference lines may be used for CCLM/MMLM mode1 parameters derivation.

In some embodiments, if the current block has N neighboring reference chroma lines, the i-th neighboring reference line is selected for deriving mode1 parameters in CCLM/MMLM, where N>1 and N≥i≥1. In some embodiments, if the current block has N neighboring reference lines, more than one reference lines may be selected for deriving mode1 parameters in CCLM/MMLM. Specifically, if the current block has N neighboring reference lines, the video coder may choose k out of N neighboring reference lines (k≥2) for deriving mode1 parameters. The selected neighboring reference lines may include the adjacent neighboring line (1^{st} reference line, or line 0) and/or non-adjacent neighboring reference lines (e.g., 2^{nd}, 3^{rd} reference lines, or lines 1, 2, 3 . . . ). For example, if 2 out of N neighboring reference lines are selected, these 2 lines may be the 1^{st} and 3^{rd} reference lines, 2^{nd} and 4^{th} reference lines, 1^{st} and 4^{th} reference lines, . . . , and so on.

In some embodiments, if a neighboring chroma reference line is selected, the video coder may select another luma reference line. The luma reference line is not required to be a corresponding luma reference line of the selected chroma reference line. For example, if the i-th chroma neighboring reference line is selected, the video coder may choose the j-th chroma neighboring reference line, where i and j may be different or the same. Moreover, the video coder may use luma reference line samples without luma downsampling process to derive mode1 parameters.

FIG. 17 illustrates various luma sample phases and chroma sample phases. The luma and chroma samples are in 4:2:0 color subsampling format. As illustrated, if the corresponding luma sample associated with a chroma sample C corresponds to Y0, Y1, Y2, Y3, and Y′0, Y′1, Y′2, Y′3 are luma samples associated with neighboring chroma samples, the video coder may choose Y0, Y1, (Y0+Y2+1)>>1, (Y′2+(Y0<<1)+Y2+2)>>2, (Y0+(Y2<<1)+Y′0+2)>>2, or (Y0+Y2−Y′2) samples at a specified neighboring luma line to derived mode1 parameters. The video coder may also choose every Y1, Y3, (Y1+Y3+1)>>1, (Y′3+(Y1<<1)+Y3+2)>>2, (Y1+(Y3<<1)+Y′1+2)>>2, or (Y1+Y3−Y′3) samples at a specified neighboring luma line to derive mode1 parameters.

In some embodiments, if a line of multiple reference lines is invalid due to the neighboring samples being not available or due to CTU row buffer size constraints, another valid reference line may be used to replace the invalid reference line. In the example of FIG. 14, which shows reference lines 0, 1, 2, . . . n, if reference line 2 is invalid but the reference lines 0 and 1 are valid, the video coder may use reference line 0 and 1 in place of reference line 2. In some embodiments, only the valid reference line(s) may be used in cross component mode1 derivation. In other words, invalid reference line(s) is (are) not used in cross component mode1 derivation.

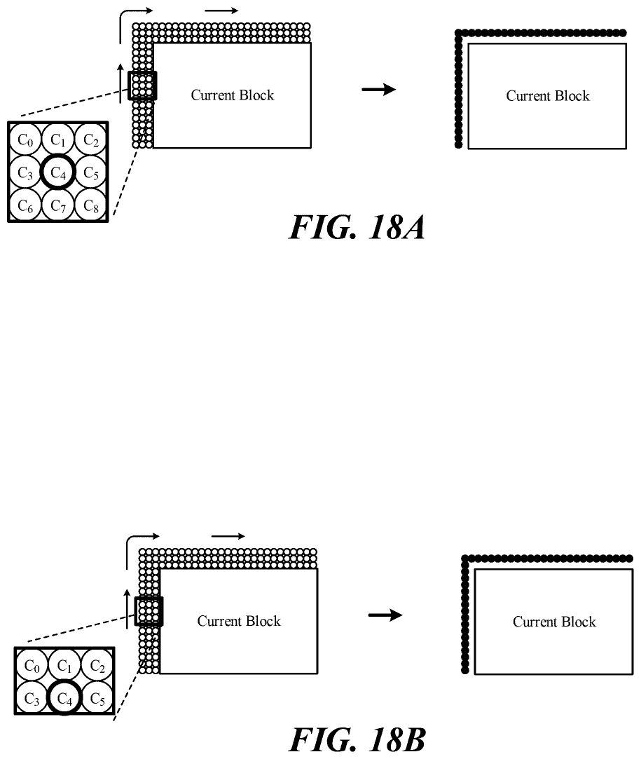

If chroma component or luma component of the current block has multiple neighboring reference lines, the video coder may combine or fuse multiple neighboring reference lines into one line to derive model parameters in CCLM/MMLM. FIGS. 18A-B illustrate multiple neighboring reference lines being combined into one line for deriving mode1 parameters in CCLM/MMLM.

In some embodiments, if three neighboring reference lines are available for the current block, the video coder may use a 3×3 window to combine three neighboring reference lines into one line and use the combined line to derive cross component mode1 parameters. The combined result of a 3×3 window is formulated as

$$( {\sum }_{i = 0}^{8} {w}_{i} \times {C}_{i} + b ) ,$$

where wᵢ would be a positive or negative value or 0, b is an offset value. FIG. 18A illustrates a 3×3 window for combining three neighboring reference lines. Similarly, the video coder may use a 3×2 window to combine three neighboring reference lines. The combined result at a 3×2 window is formulated as

$$( {\sum }_{i = 0}^{5} {w}_{i} \times {C}_{i} + b ) ,$$

where wᵢ could be a positive or negative value, b is an offset value. FIG. 18B illustrates a 3×2 window for combining three neighboring reference lines.

In the examples above, (may be neighboring luma or chroma samples. In still another embodiment, a generalized formula is

$$( {\sum }_{i = 0}^{s} {w}_{i} \times {L}_{i} + {\sum }_{i = 0}^{s} {w}_{i} \times {C}_{i} + b ) ,$$

where Lᵢ and Cᵢ are the neighboring luma and chroma samples, S′ is the applied window size, w′, may be a positive or negative value or 0, b is an offset value.

In some embodiments, the mode1 derivation of CCLM/MMLM is based on different neighboring reference lines selection, and the indication of the selected lines of CCLM/MMLM is explicitly determined or implicitly derived. For example, if one or two reference lines are allowed for the current block, and the selected lines of CCLM/MMLM is explicitly determined, a first bin is used to indicate whether one line or two line is used. Then, a second bin or more bins (coded by truncate unary or fix length code) are used to indicate which reference line or what lines combination is selected. For example, if one reference line is used, the signaling may indicate a selection among {1^{st} line, 2^{nd} line, 3^{rd} line . . . }. If two reference lines are used, the signaling may indicate a selection among {1^{st} line+2^{nd} line, 2^{nd} line+3^{rd} line, 1^{st} line+3^{rd} line . . . }.

The selected lines of CCLM/MMLM may be implicitly derived by using decoder side tools, e.g., by using template matching cost or boundary matching cost. For example, at the decoder side, the final line selection of the current block is the CCLM/MMLM with the line(s) that can minimize the difference of the boundary samples of the current block and the neighboring samples of the current block. In some embodiments, at the decoder side, the final line selection of the current block is the CCLM/MMLM with the line(s) that can minimize the distortion of samples in the neighboring template. For example, after deriving mode1 parameters of a CCLM/MMLM by a certain reference line, the mode1 is applied to the luma samples of the neighboring template to obtain the predicted chroma samples, and the cost is calculated based on the difference between the predicted chroma samples and the reconstructed chroma samples in the neighboring template. The video coder may derive mode1 parameters of a CCLM/MMLM by using another reference line, with the derived mode1 applied to the luma samples of the neighboring template to determine a cost. The costs of the different models derived from different reference lines are then compared. The final chroma prediction of the current block is generated by selecting and using a model/reference line having the smallest cost.

In addition, the usage of more than one reference lines may depend on the current block size or the mode of CCLM/MMLM. In some embodiments, if the current block width is less than a threshold, then more than one reference lines are used in CCLM_A or MMLM_A. Similarly, if the current block height is less than a threshold, then more than one reference lines are used in CCLM_L or MMLM L. If the (width+height) of the current block is less than a threshold, then more than one reference lines are used in CCLM LA or MMLM_LA. For still another example, in some embodiments, if the area of the current block is less than a threshold, then more than two reference lines are used in CCLM or MMLM. In another embodiment, more than one reference lines are used in CCLM_A, CCLM_L, MMLM_A, or MMLM L. In still another embodiment, a syntax may be signaled at SPS, PPS, PH, SH, CTU, CU, or PU level to indicate if more than one reference lines is allowed for the current block.

LM modes described herein may refer to one or more than one CCLM modes and/or one or more than one MMLM modes. LM modes may refer to any modes which uses cross-component information to predict the current component. LM modes may also refer to any extensions/variations from CCLM and/or MMLM modes.

The proposed methods in this invention can be enabled and/or disabled according to implicit rules (e.g., block width, height, or area) or according to explicit rules (e.g., syntax on block, tile, slice, picture, SPS, or PPS level). For example, reordering may be applied when the block area is smaller than a threshold. The term “block” in this invention can refer to TU/TB, CU/CB, PU/PB, pre-defined region, or CTU/CTB.

For template-related methods in this disclosure, the size of a template can may vary with the block width, block height, or block area. For larger blocks, the template size can be larger. For smaller blocks, the template size can be smaller. For example, the template thickness is set as 4 for larger blocks set as 2 for smaller blocks. In some embodiments, the reference line for the template prediction and/or the current block prediction is inferred as the line adjacent to the template. In some embodiments, the reference line for the template prediction and/or the current block prediction is indicated as the line adjacent or non-adjacent to the template or current block.

Any combination of the proposed methods in this invention can be applied.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

### XI. Example Video Encoder

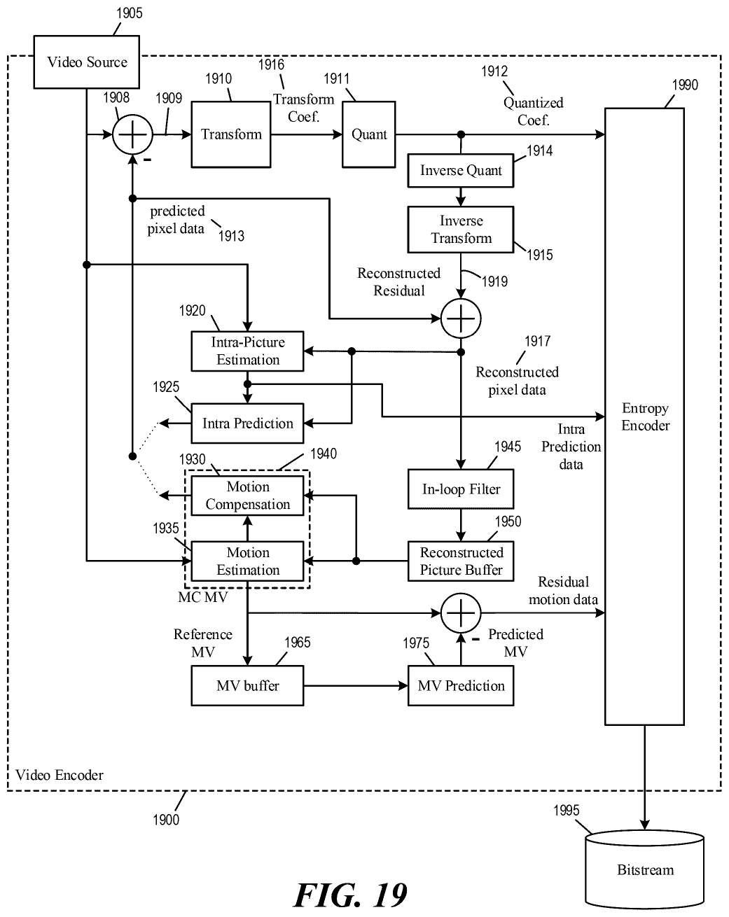

FIG. 19 illustrates an example video encoder 1900 that may use multiple reference lines when encoding a block of pixels. As illustrated, the video encoder 1900 receives input video signal from a video source 1905 and encodes the signal into bitstream 1995. The video encoder 1900 has several components or modules for encoding the signal from the video source 1905, at least including some components selected from a transform module 1910, a quantization module 1911, an inverse quantization module 1914, an inverse transform module 1915, an intra-picture estimation module 1920, an intra-prediction module 1925, a motion compensation module 1930, a motion estimation module 1935, an in-loop filter 1945, a reconstructed picture buffer 1950, a MV buffer 1965, and a MV prediction module 1975, and an entropy encoder 1990. The motion compensation module 1930 and the motion estimation module 1935 are part of an inter-prediction module 1940.

In some embodiments, the modules 1910-1990 are modules of software instructions being executed by one or more processing units (e.g., a processor) of a computing device or electronic apparatus. In some embodiments, the modules 1910-1990 are modules of hardware circuits implemented by one or more integrated circuits (ICs) of an electronic apparatus. Though the modules 1910-1990 are illustrated as being separate modules, some of the modules can be combined into a single module.

The video source 1905 provides a raw video signal that presents pixel data of each video frame without compression. A subtractor 1908 computes the difference between the raw video pixel data of the video source 1905 and the predicted pixel data 1913 from the motion compensation module 1930 or intra-prediction module 1925 as prediction residual 1909. The transform module 1910 converts the difference (or the residual pixel data or residual signal 1908) into transform coefficients (e.g., by performing Discrete Cosine Transform, or DCT). The quantization module 1911 quantizes the transform coefficients into quantized data (or quantized coefficients) 1912, which is encoded into the bitstream 1995 by the entropy encoder 1990.

The inverse quantization module 1914 de-quantizes the quantized data (or quantized coefficients) 1912 to obtain transform coefficients, and the inverse transform module 1915 performs inverse transform on the transform coefficients to produce reconstructed residual 1919. The reconstructed residual 1919 is added with the predicted pixel data 1913 to produce reconstructed pixel data 1917. In some embodiments, the reconstructed pixel data 1917 is temporarily stored in a line buffer (not illustrated) for intra-picture prediction and spatial MV prediction. The reconstructed pixels are filtered by the in-loop filter 1945 and stored in the reconstructed picture buffer 1950. In some embodiments, the reconstructed picture buffer 1950 is a storage external to the video encoder 1900. In some embodiments, the reconstructed picture buffer 1950 is a storage internal to the video encoder 1900.

The intra-picture estimation module 1920 performs intra-prediction based on the reconstructed pixel data 1917 to produce intra prediction data. The intra-prediction data is provided to the entropy encoder 1990 to be encoded into bitstream 1995. The intra-prediction data is also used by the intra-prediction module 1925 to produce the predicted pixel data 1913.

The motion estimation module 1935 performs inter-prediction by producing MVs to reference pixel data of previously decoded frames stored in the reconstructed picture buffer 1950. These MVs are provided to the motion compensation module 1930 to produce predicted pixel data.

Instead of encoding the complete actual MVs in the bitstream, the video encoder 1900 uses MV prediction to generate predicted MVs, and the difference between the MVs used for motion compensation and the predicted MVs is encoded as residual motion data and stored in the bitstream 1995.

The MV prediction module 1975 generates the predicted MVs based on reference MVs that were generated for encoding previously video frames, i.e., the motion compensation MVs that were used to perform motion compensation. The MV prediction module 1975 retrieves reference MVs from previous video frames from the MV buffer 1965. The video encoder 1900 stores the MVs generated for the current video frame in the MV buffer 1965 as reference MVs for generating predicted MVs.

The MV prediction module 1975 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1995 by the entropy encoder 1990.

The entropy encoder 1990 encodes various parameters and data into the bitstream 1995 by using entropy-coding techniques such as context-adaptive binary arithmetic coding (CABAC) or Huffman encoding. The entropy encoder 1990 encodes various header elements, flags, along with the quantized transform coefficients 1912, and the residual motion data as syntax elements into the bitstream 1995. The bitstream 1995 is in turn stored in a storage device or transmitted to a decoder over a communications medium such as a network.

The in-loop filter 1945 performs filtering or smoothing operations on the reconstructed pixel data 1917 to reduce the artifacts of coding, particularly at boundaries of pixel blocks. In some embodiments, the filtering or smoothing operations performed by the in-loop filter 1945 include deblock filter (DBF), sample adaptive offset (SAO), and/or adaptive loop filter (ALF).

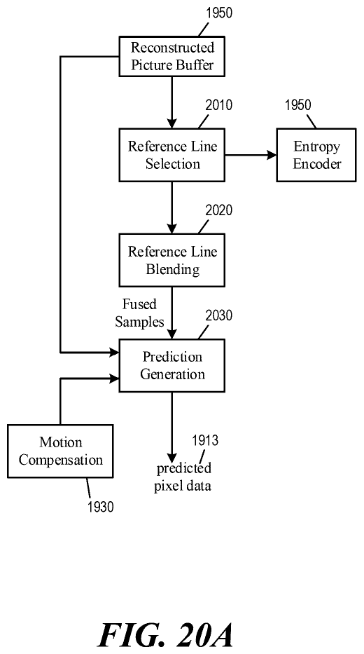

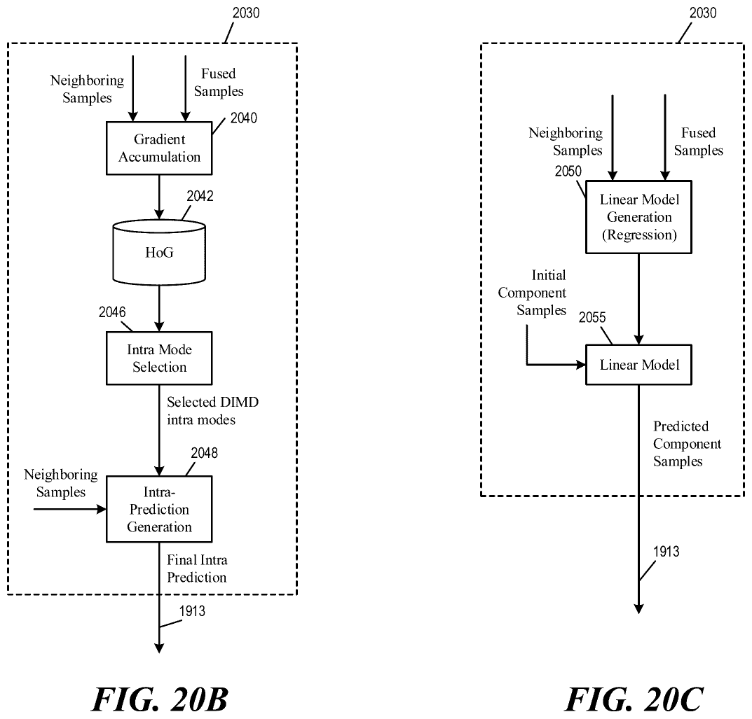

FIGS. 20A-C illustrate portions of the video encoder 1900 that implement predictions by multiple reference lines. As illustrated in FIG. 20A, a reference line selection module 2010 selects one or more reference lines. Indications of the selected reference lines are provided to the entropy encoder 1990, which may signal one index that represents a combination that includes the selected reference lines, or multiple indices that represent the selected reference lines individually.

Based on the reference line selection, corresponding samples are fetched from the reconstructed picture buffer 1950. The fetched samples are provided to a reference line blending module 2020, which uses the fetched samples to generate a fused reference line having blended or fused samples. The fused samples of the fused reference line are in turn provided to a prediction generation module 2030. The prediction generation module 2030 uses the fused samples and other samples from the reconstructed picture buffer 1950 and/or the motion compensation module 1930 to generate a prediction of the current block as the predicted pixel data 1913.

In some embodiments, the prediction generation module 2030 uses the samples of the fused reference line to perform DIMD intra prediction. FIG. 20B illustrates the components of the prediction generation module 2030 that are used to perform DIMD. As illustrated, a gradient accumulation module 2040 derives a histogram of gradients (HoG) 2042 having bins corresponding to different intra prediction angles. The entries made to the bins of the HoG are generated based on gradient computed from the blended samples of the fused reference line (provided by the reference line blending module 2020) and/or neighboring samples of the current block (provided by the reconstructed picture buffer 1950.) An intra mode selection module 2046 uses the HoG to identify two or more DIMD intra modes, and an intra-prediction generation module 2048 generates a prediction/predictor for the current block based on the two or more DIMD intra modes.

In some embodiments, the prediction generation module 2030 uses the luma/chroma component samples of the fused reference line to derive a linear model and to perform cross component prediction. FIG. 20C illustrates components of the prediction generation module 2030 that are used to perform cross component prediction. As illustrated, a linear model generation module 2050 uses component samples (luma or chroma) of the fused reference line and/or other reference lines to generate a linear model 2055, by e.g., performing data regression. In some embodiments, the generated linear model 2055 may be applied to an initial predictor of the current block (e.g., an inter-prediction by motion compensation) to generate a refined predictor of the current block. In some embodiments, the generated linear model may be applied to luma samples of the current block to generate predicted chroma samples of the current block.

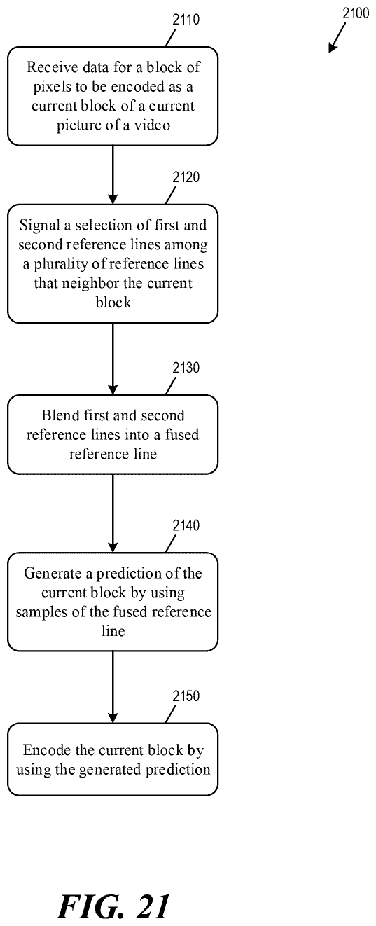

FIG. 21 conceptually illustrates a process 2100 that uses multiple reference line to generate a prediction when encoding a block of pixels. In some embodiments, one or more processing units (e.g., a processor) of a computing device implementing the encoder 1900 performs the process 2100 by executing instructions stored in a computer readable medium. In some embodiments, an electronic apparatus implementing the encoder 1900 performs the process 2100.

The encoder receives (at block 2110) data to be encoded as a current block of pixels in a current picture of a video. The encoder signals (at block 2120) a selection of first and second reference lines among multiple reference lines that neighbor the current block. Each reference line includes a set of pixel samples that forms an L-shape near the current block (e.g., above and left). The multiple reference lines may include one reference line that is adjacent to the current block and two or more reference lines that are not adjacent to the current block. For example, the first reference line may be adjacent to the current block, or both the first and second reference lines are not adjacent to the current block.

In some embodiments, the selection of the first and second reference lines includes an index that represents a combination that includes the first and second reference lines, where different combinations of two or more reference lines are represented by different indices. The different indices representing different combinations of reference lines are determined based on costs of the different combinations (e.g., the different combinations are ordered based on costs.) In some embodiments, each combination further specifies an intra-prediction mode by which an intra-prediction of the current block is generated based on the fused reference line. In some embodiments, the selection of the first and second reference lines includes first and second indices. The first index may identify the first reference line and the second index may be an offset to be added to the first index for identifying the second reference line.

The encoder blends (at block 2130) first and second reference lines to generate a fused reference line. The encoder generates (at block 2140) a prediction of the current block by using samples of the fused reference line. In some embodiments, the encoder may perform DIMD intra prediction based on the fused reference line. Specifically, the encoder derives a HoG having bins that correspond to different intra prediction angles, where an entry is made to a bin when a gradient computed based on the fused reference line indicates a particular intra prediction angle that corresponds to the bin. The encoder may identify two or more intra prediction modes based on the HoG and generate the prediction of the current block based on the identified two or more intra prediction modes.

In some embodiments, the encoder may perform cross-component prediction based on the fused reference line. For example, the encoder may derive a linear model based on luma and chroma component samples of the fused reference line, with the prediction of the current block being chroma prediction that is generated by applying the derived linear model to luma samples of the current block.

The encoder encodes (at block 2150) the current block by using the generated prediction to produce prediction residuals.

### XII. Example Video Decoder

In some embodiments, an encoder may signal (or generate) one or more syntax element in a bitstream, such that a decoder may parse said one or more syntax element from the bitstream.

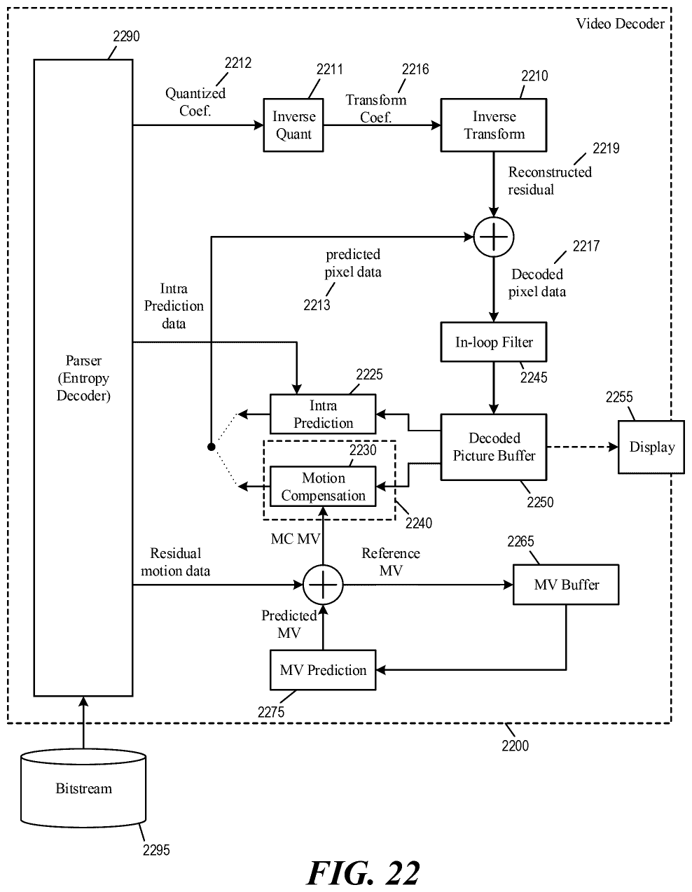

FIG. 22 illustrates an example video decoder 2200 that may use multiple reference lines when decoding a block of pixels. As illustrated, the video decoder 2200 is an image-decoding or video-decoding circuit that receives a bitstream 2295 and decodes the content of the bitstream into pixel data of video frames for display. The video decoder 2200 has several components or modules for decoding the bitstream 2295, including some components selected from an inverse quantization module 2211, an inverse transform module 2210, an intra-prediction module 2225, a motion compensation module 2230, an in-loop filter 2245, a decoded picture buffer 2250, a MV buffer 2265, a MV prediction module 2275, and a parser 2290. The motion compensation module 2230 is part of an inter-prediction module 2240. In some embodiments, the modules 2210-2290 are modules of software instructions being executed by one or more processing units (e.g., a processor) of a computing device. In some embodiments, the modules 2210-2290 are modules of hardware circuits implemented by one or more ICs of an electronic apparatus. Though the modules 2210-2290 are illustrated as being separate modules, some of the modules can be combined into a single module.

The parser 2290 (or entropy decoder) receives the bitstream 2295 and performs initial parsing according to the syntax defined by a video-coding or image-coding standard. The parsed syntax element includes various header elements, flags, as well as quantized data (or quantized coefficients) 2212. The parser 2290 parses out the various syntax elements by using entropy-coding techniques such as context-adaptive binary arithmetic coding (CABAC) or Huffman encoding.

The inverse quantization module 2211 de-quantizes the quantized data (or quantized coefficients) 2212 to obtain transform coefficients, and the inverse transform module 2210 performs inverse transform on the transform coefficients 2216 to produce reconstructed residual signal 2219. The reconstructed residual signal 2219 is added with predicted pixel data 2213 from the intra-prediction module 2225 or the motion compensation module 2230 to produce decoded pixel data 2217. The decoded pixels data are filtered by the in-loop filter 2245 and stored in the decoded picture buffer 2250. In some embodiments, the decoded picture buffer 2250 is a storage external to the video decoder 2200. In some embodiments, the decoded picture buffer 2250 is a storage internal to the video decoder 2200.

The intra-prediction module 2225 receives intra-prediction data from bitstream 2295 and according to which, produces the predicted pixel data 2213 from the decoded pixel data 2217 stored in the decoded picture buffer 2250. In some embodiments, the decoded pixel data 2217 is also stored in a line buffer (not illustrated) for intra-picture prediction and spatial MV prediction.

In some embodiments, the content of the decoded picture buffer 2250 is used for display. A display device 2255 either retrieves the content of the decoded picture buffer 2250 for display directly, or retrieves the content of the decoded picture buffer to a display buffer. In some embodiments, the display device receives pixel values from the decoded picture buffer 2250 through a pixel transport.

The motion compensation module 2230 produces predicted pixel data 2213 from the decoded pixel data 2217 stored in the decoded picture buffer 2250 according to motion compensation MVs (MC MVs). These motion compensation MVs are decoded by adding the residual motion data received from the bitstream 2295 with predicted MVs received from the MV prediction module 2275.

The MV prediction module 2275 generates the predicted MVs based on reference MVs that were generated for decoding previous video frames, e.g., the motion compensation MVs that were used to perform motion compensation. The MV prediction module 2275 retrieves the reference MVs of previous video frames from the MV buffer 2265. The video decoder 2200 stores the motion compensation MVs generated for decoding the current video frame in the MV buffer 2265 as reference MVs for producing predicted MVs.

The in-loop filter 2245 performs filtering or smoothing operations on the decoded pixel data 2217 to reduce the artifacts of coding, particularly at boundaries of pixel blocks. In some embodiments, the filtering or smoothing operations performed by the in-loop filter 2245 include deblock filter (DBF), sample adaptive offset (SAO), and/or adaptive loop filter (ALF).

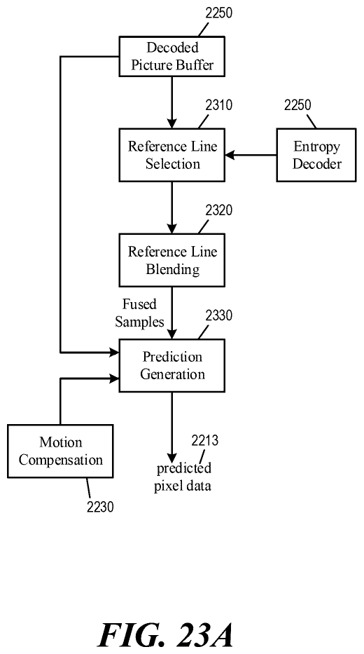

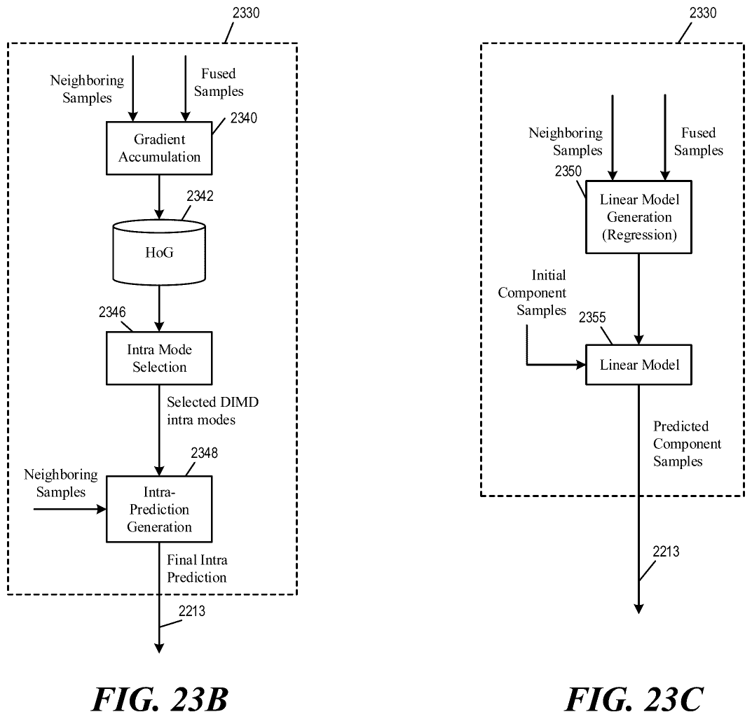

FIGS. 23A-C illustrate portions of the video decoder 2200 that implement predictions by multiple reference lines. As illustrated in FIG. 23A, a reference line selection module 2310 selects one or more reference lines. Indications of the selected reference lines are provided by the entropy decoder 2290, which may receive one index that represents a combination that includes the selected reference lines, or multiple indices that represent the selected reference lines individually.

Based on the reference line selection, corresponding samples are fetched from the decoded picture buffer 2250. The fetched samples are provided to a reference line blending module 2320, which uses the fetched samples to generate a fused reference line having blended or fused samples. The fused samples of the fused reference line are in turn provided to a prediction generation module 2330. The prediction generation module 2330 uses the fused samples and other samples from the decoded picture buffer 2250 and/or the motion compensation module 2230 to generate a prediction of the current block as the predicted pixel data 2213.

In some embodiments, the prediction generation module 2330 uses the samples of the fused reference line to perform DIMD intra prediction. FIG. 23B illustrates the components of the prediction generation module 2330 that are used to perform DIMD. As illustrated, a gradient accumulation module 2340 derives a histogram of gradients (HoG) 2342 having bins corresponding to different intra prediction angles. The entries made to the bins of the HoG are generated based on gradient computed from the blended samples of the fused reference line (provided by the reference line blending module 2320) and/or neighboring samples of the current block (provided by the decoded picture buffer 2250.) An intra mode selection module 2346 uses the HoG to identify two or more DIMD intra modes, and an intra-prediction generation module 2348 generates a prediction/predictor for the current block based on the two or more DIMD intra modes.

In some embodiments, the prediction generation module 2330 uses the luma/chroma component samples of the fused reference line to derive a linear model and to perform cross component prediction. FIG. 23C illustrates components of the prediction generation module 2330 that are used to perform cross component prediction. As illustrated, a linear model generation module 2350 uses component samples (luma or chroma) of the fused reference line and/or other reference lines to generate a linear model 2355, by e.g., performing data regression. In some embodiments, the generated linear model 2355 may be applied to an initial predictor of the current block (e.g., an inter-prediction by motion compensation) to generate a refined predictor of the current block. In some embodiments, the generated linear model may be applied to luma samples of the current block to generate predicted chroma samples of the current block.

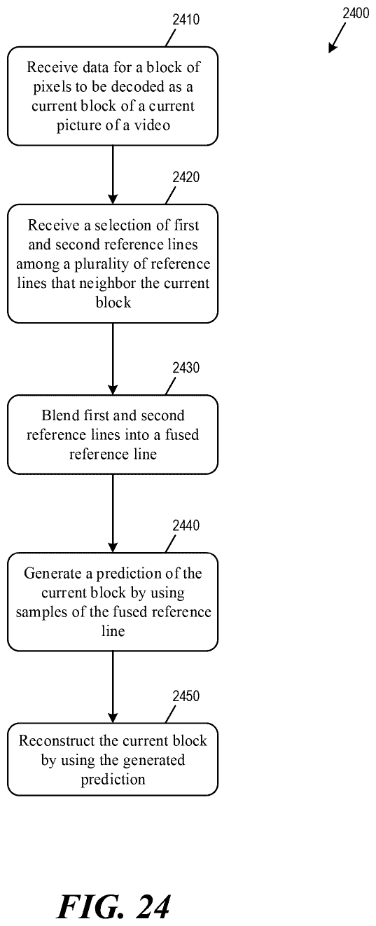

FIG. 24 conceptually illustrates a process 2400 that uses multiple reference line to generate a prediction when decoding a block of pixels. In some embodiments, one or more processing units (e.g., a processor) of a computing device implementing the decoder 2200 performs the process 2400 by executing instructions stored in a computer readable medium. In some embodiments, an electronic apparatus implementing the decoder 2200 performs the process 2400.

The decoder receives (at block 2410) data to be decoded as a current block of pixels in a current picture of a video. The decoder receives (at block 2420) a selection of first and second reference lines among multiple reference lines that neighbor the current block. Each reference line includes a set of pixel samples that forms an L-shape near the current block (e.g., above and left). The multiple reference lines may include one reference line that is adjacent to the current block and two or more reference lines that are not adjacent to the current block. For example, the first reference line may be adjacent to the current block, or both the first and second reference lines are not adjacent to the current block.

In some embodiments, the selection of the first and second reference lines includes an index that represents a combination that includes the first and second reference lines, where different combinations of two or more reference lines are represented by different indices. The different indices representing different combinations of reference lines are determined based on costs of the different combinations (e.g., the different combinations are ordered based on costs.) In some embodiments, each combination further specifies an intra-prediction mode by which an intra-prediction of the current block is generated based on the fused reference line. In some embodiments, the selection of the first and second reference lines includes first and second indices. The first index may identify the first reference line and the second index may be an offset to be added to the first index for identifying the second reference line.

The decoder blends (at block 2430) first and second reference lines to generate a fused reference line. The decoder generates (at block 2440) a prediction of the current block by using samples of the fused reference line. In some embodiments, the decoder may perform DIMD intra prediction based on the fused reference line. Specifically, the decoder derives a HoG having bins that correspond to different intra prediction angles, where an entry is made to a bin when a gradient computed based on the fused reference line indicates a particular intra prediction angle that corresponds to the bin. The decoder may identify two or more intra prediction modes based on the HoG and generate the prediction of the current block based on the identified two or more intra prediction modes.

In some embodiments, the decoder may perform cross-component prediction based on the fused reference line. For example, the decoder may derive a linear model based on luma and chroma component samples of the fused reference line, with the prediction of the current block being chroma prediction that is generated by applying the derived linear model to luma samples of the current block.

The decoder reconstructs (at block 2450) the current block by using the generated prediction. The decoder may then provide the reconstructed current block for display as part of the reconstructed current picture.

### XIII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

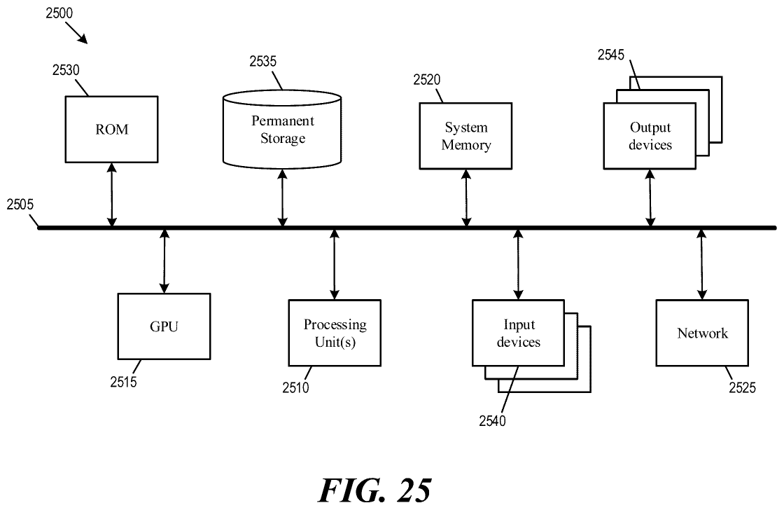

FIG. 25 conceptually illustrates an electronic system 2500 with which some embodiments of the present disclosure are implemented. The electronic system 2500 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2500 includes a bus 2505, processing unit(s) 2510, a graphics-processing unit (GPU) 2515, a system memory 2520, a network 2525, a read-only memory 2530, a permanent storage device 2535, input devices 2540, and output devices 2545.

The bus 2505 collectively represents all system, peripheral, and chipset buses that communicatively connect the numerous internal devices of the electronic system 2500. For instance, the bus 2505 communicatively connects the processing unit(s) 2510 with the GPU 2515, the read-only memory 2530, the system memory 2520, and the permanent storage device 2535.

From these various memory units, the processing unit(s) 2510 retrieves instructions to execute and data to process in order to execute the processes of the present disclosure. The processing unit(s) may be a single processor or a multi-core processor in different embodiments. Some instructions are passed to and executed by the GPU 2515. The GPU 2515 can offload various computations or complement the image processing provided by the processing unit(s) 2510.

The read-only-memory (ROM) 2530 stores static data and instructions that are used by the processing unit(s) 2510 and other modules of the electronic system. The permanent storage device 2535, on the other hand, is a read-and-write memory device. This device is a non-volatile memory unit that stores instructions and data even when the electronic system 2500 is off. Some embodiments of the present disclosure use a mass-storage device (such as a magnetic or optical disk and its corresponding disk drive) as the permanent storage device 2535.

Other embodiments use a removable storage device (such as a floppy disk, flash memory device, etc., and its corresponding disk drive) as the permanent storage device. Like the permanent storage device 2535, the system memory 2520 is a read-and-write memory device. However, unlike storage device 2535, the system memory 2520 is a volatile read-and-write memory, such a random access memory. The system memory 2520 stores some of the instructions and data that the processor uses at runtime. In some embodiments, processes in accordance with the present disclosure are stored in the system memory 2520, the permanent storage device 2535, and/or the read-only memory 2530. For example, the various memory units include instructions for processing multimedia clips in accordance with some embodiments. From these various memory units, the processing unit(s) 2510 retrieves instructions to execute and data to process in order to execute the processes of some embodiments.

The bus 2505 also connects to the input and output devices 2540 and 2545. The input devices 2540 enable the user to communicate information and select commands to the electronic system. The input devices 2540 include alphanumeric keyboards and pointing devices (also called “cursor control devices”), cameras (e.g., webcams), microphones or similar devices for receiving voice commands, etc. The output devices 2545 display images generated by the electronic system or otherwise output data. The output devices 2545 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 25, bus 2505 also couples electronic system 2500 to a network 2525 through a network adapter (not shown). In this manner, the computer can be a part of a network of computers (such as a local area network (“LAN”), a wide area network (“WAN”), or an Intranet, or a network of networks, such as the Internet. Any or all components of electronic system 2500 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 21 and FIG. 24) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A video coding method comprising:
receiving data for a block of pixels to be encoded or decoded as a current block of a current picture of a video;
receiving or signaling a selection of first and second reference lines among a plurality of reference lines that neighbor the current block;
blending the first and second reference lines into a fused reference line;
generating a prediction of the current block by using samples of the fused reference line; and
encoding or decoding the current block by using the generated prediction.

2. The video coding method of claim 1, further comprising:
deriving a histogram of gradients (HoG) comprising a plurality of bins corresponding to different intra prediction angles, wherein an entry is made to a bin when a gradient computed based on the fused reference line indicates a particular intra prediction angle that corresponds to the bin; and
identifying two or more intra prediction modes based on the HoG,
wherein the prediction of the current block is generated based on the identified two or more intra prediction modes.

3. The video coding method of claim 1, further comprising deriving a linear model based on luma and chroma component samples of the fused reference line, wherein the prediction of the current block is chroma prediction generated by applying the derived linear model to luma samples of the current block.

4. The video coding method of claim 1, wherein each reference line comprises a set of pixel samples that forms an L-shape near the current block.

5. The video coding method of claim 1, wherein the plurality of reference lines comprise one reference line that is adjacent to the current block and two or more reference lines that are not adjacent to the current block.

6. The video coding method of claim 5, wherein the first reference line is adjacent to the current block;

7. The video coding method of claim 5, wherein the first and second reference lines are not adjacent to the current block.

8. The video coding method of claim 1, wherein the selection of the first and second reference lines comprises an index that represents a combination that includes the first and second reference lines, wherein different combinations of two or more reference lines are represented by different indices.

9. The video coding method of claim 8, wherein the different indices representing different combinations of reference lines are determined based on costs of the different combinations.

10. The video coding method of claim 8, wherein each combination further specifies an intra-prediction mode by which the prediction of the current block is generated based on the fused reference line.

11. The video coding method of claim 1, wherein the received or signaled selection of the first and second reference lines comprises first and second indices.

12. The video coding method of claim 11, wherein the first index identifies the first reference line and the second index is an offset to be added to the first index for identifying the second reference line.

13. An electronic apparatus comprising:
a video coder circuit configured to perform operations comprising:
receiving data for a block of pixels to be encoded or decoded as a current block of a current picture of a video;
receiving or signaling a selection of first and second reference lines among a plurality of reference lines that neighbor the current block;
blending the first and second reference lines into a fused reference line;
generating a prediction of the current block by using samples of the fused reference line; and
encoding or decoding the current block by using the generated prediction.

14. A video decoding method comprising:
receiving data for a block of pixels to be decoded as a current block of a current picture of a video;
receiving or signaling a selection of first and second reference lines among a plurality of reference lines that neighbor the current block;
blending the first and second reference lines into a fused reference line;
generating a prediction of the current block by using samples of the fused reference line; and
reconstructing the current block by using the generated prediction.

15. (canceled)
